(19) United States
(12) Patent Application Publication
(10) Pub. No.: US 2011/0001907 A1
(43) Pub. Date: Jan. 6, 2011

(54) CELLULOSE ESTER FILM, RETARDATION FILM USING THE SAME, POLARIZING PLATE AND LIQUID CRYSTAL DISPLAY DEVICE

(75) Inventors: Mamoru Sakurazawa, Kanagawa (JP); Yasuo Mukunoki, Kanagawa (JP); Hiroaki Sata, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/920,370

(22) PCT Filed: Dec. 22, 2008
(86) PCT No.: PCT/JP2008/073334

§ 371 Date: Aug. 31, 2010

(30) Foreign Application Priority Data
Mar. 6, 2008 (JP) 2008-056913
Nov. 25, 2008 (JP) 2008-299454

(51) Int. Cl. G02F 1/1335; G02B 27/28; C08B 3/16

(52) U.S. Cl. 349/96; 349/117; 359/485; 536/64; 536/65

(57) ABSTRACT

Thanks to a cellulose ester film comprising at least one kind of a polycondensed ester obtained from at least one kind of an aliphatic diol having an average carbon number of 2.0 to 2.5 and a dicarboxylic acid mixture containing at least one kind of an aromatic ring-containing dicarboxylic acid and at least one kind of an aliphatic dicarboxylic acid and having an average carbon number of 6.0 to 10.0, an excellent cellulose ester film yielding little process contamination at the production and ensuring high production efficiency, a retardation film with excellent characteristics, and a polarizing plate and a liquid crystal display device each using the film, are provided.

### TECHNICAL FIELD

The present invention relates to a cellulose ester film, a retardation film using the same, a polarizing plate and a liquid crystal display device.

### BACKGROUND ART

A polymer film of typically cellulose ester, polyester, polycarbonate, cycloolefin polymer, vinyl polymer, polyimide or the like is used in silver halide photographic materials, retardation films, polarizing plates and image display devices. A film that is more excellent in terms of planarity and uniformity can be produced from such a polymer and therefore, the polymer film is widely employed as a film for optical application. For example, a cellulose ester film having appropriate moisture permeability can be laminated online directly to a most popular polarizing film composed of polyvinyl alcohol (PVA)/iodine. Therefore, a cellulose ester, particularly cellulose acetate, is widely employed as a protective film for polarizing plates.

In the case where a transparent polymer film is used for optical application such as retardation film, retardation film support, polarizing plate protective film and liquid crystal display device, control of the optical anisotropy is a very important factor in determining the display device performance (for example, visibility).

On the other hand, a solution film-forming method is widely utilized as the method for producing a cellulose ester film for use in optical application. In this case, a plasticizer is preferably added for the purpose of imparting high-speed film formation suitability at the production, because addition of a plasticizer enables a solvent to volatilize in a short time at the drying in the solution film production. However, a transparent polymer film containing a plasticizer that is usually used may cause an undesired phenomenon when treated under severe conditions in the production process, or the plasticizer may adversely affect the film. For example, when the transparent polymer film is treated at a high temperature, smoking or contamination with an oil may occur. Therefore, the production conditions or treatment conditions for a transparent polymer film using a plasticizer are naturally subject to restrictions.

A technique of adding, as the polymer plasticizer, a polyester or polyester ether having a weight average molecular weight of 400 to 5,000 is disclosed (see, Patent Document 1). This technique is supposed to provide an excellent effect in the material deposition prevention, moisture permeability and dimension but is not satisfied with the process contamination at the production or the raw material volatilization during stretching at a high temperature. Also, a cellulose ester film containing a polyester having an aromatic ring is disclosed (see, for example, Patent Documents 2 and 3). However, even such a compound is insufficient in view of process contamination during the production and performance with aging in the form of a polarizing plate.

On the other hand, it is a widely known technique to use an optically compensatory film in a liquid crystal display device for enlarging the viewing angle, improving the image coloration and enhancing the contrast. In the most widespread VA (Vertically Aligned) mode, TN mode or the like, an optically compensatory film having large optical properties is particularly demanded.

The adjustment to optical properties suitable for VA mode requires a stretching treatment and also, a countermeasure against surface failure due to process contamination at the production is strongly demanded.

Patent Document 1: JP-A-2002-022956 (the term “JP-A” as used herein means an “unexamined published Japanese patent application”)

Patent Document 2: JP-A-2007-003767

Patent Document 3: JP-A-2006-64803

### DISCLOSURE OF THE INVENTION

### Problems that the Invention is to Solve

An object of the present invention is to provide an excellent cellulose ester film yielding little process contamination at the production and ensuring high production efficiency.

Another object of the present invention is to provide a retardation film and a polarizing plate each using the cellulose ester film above, ensuring that the surface state is good, the Re and Rth values can be controlled to desired values, and the durability is excellent.

Still another object of the present invention is to provide a liquid crystal display device using the polarizing plate above and having good display quality.

### Means for Solving the Problems

As a result of intensive studies, the present inventors have found that the cellulose ester film of the present invention containing an aromatic-aliphatic copolycondensed ester is reduced in the process contamination at the production and causes little change in the performance with aging of a polarizing plate.

That is, the above-described objects are attained by the following configurations.

1. A cellulose ester film comprising at least one kind of a polycondensed ester obtained from at least one kind of an aliphatic diol having an average carbon number of 2.0 to 2.5 and a dicarboxylic acid mixture containing at least one kind of an aromatic ring-containing dicarboxylic acid and at least one kind of an aliphatic dicarboxylic acid and having an average carbon number of 6.0 to 10.0.

2. The cellulose ester film as described in 1 above, wherein the polycondensed ester is a polyester polyol or the terminal end of the polycondensed ester is an ester-forming derivative of an aliphatic monocarboxylic acid having a carbon number of 3 or less.

3. The cellulose ester film as described in 1 or 2 above, wherein the terminal end of the polycondensed ester is an ester-forming derivative of acetic acid or propionic acid.

4. The cellulose ester film as described in any one of 1 to 3 above, wherein the cellulose ester film is obtained by stretching, and the stretch ratio is from 5 to 100% in the direction perpendicular to the conveying direction (in the width direction).

5. The cellulose ester film as described in any one of 1 to 4 above, which contains a compound having at least two or more aromatic rings.

6. The cellulose ester film as described in 4 or 5 above, wherein the stretching is performed with a residual solvent amount of 5% or less, the residual solvent amount being defined as follows:

residual solvent amount=(mass of residual volatile component/mass of film after heat treatment)×100%.

7. The cellulose ester film as described in any one of 1 to 6 above, wherein the cellulose ester film contains a cellulose acylate and the acyl substitution degree of the cellulose acylate is from 2.00 to 2.95.

8. A retardation film comprising the cellulose ester film described in any one of 1 to 7 above having thereon an optically anisotropic layer containing at least one kind of a liquid crystalline compound.

9. A polarizing plate comprising a polarizer having on both sides thereof a protective film, wherein at least one of the protective films is the cellulose ester film described in any one of 1 to 7 above or the retardation film described in 8 above.

10. A liquid crystal display device comprising a liquid crystal cell and two polarizing plates disposed on both sides of the liquid crystal cell, wherein at least one of the polarizing plates is the polarizing plate described in 9 above.

11. The liquid crystal display device as described in 10 above, wherein the liquid crystal cell is a vertically aligned-mode or TN-mode liquid crystal cell.

### ADVANTAGE OF THE INVENTION

According to the present invention, a cellulose ester film, a retardation film and a polarizing plate, ensuring that process contamination at the production is reduced, the production efficiency is high, the surface state is good, the Re and Rth values can be controlled to desired values and the durability is excellent, can be provided. Also, a liquid crystal display device using the film or polarizing plate above and having good display quality can be provided.

### BEST MODE FOR CARRYING OUT THE INVENTION

The present invention is described in detail below. Incidentally, in the specification of the present invention, the expression “(numerical value 1)-(numerical value 2)” or “from (numerical value 1) to (numerical value 2)” used to indicate a physical value, a characteristic value or the like means “(numerical value 1) or more and (numerical value 2) or less”.

The present invention relates to a cellulose ester film comprising at least one kind of a polycondensed ester obtained from at least one kind of an aliphatic diol having an average carbon number of 2.0 to 2.5 and a dicarboxylic acid mixture containing at least one kind of an aromatic ring-containing dicarboxylic acid and at least one kind of an aliphatic dicarboxylic acid and having an average carbon number of 6.0 to 10.0. The present invention is described in more detail below.

### [Polycondensed Ester]

The polycondensed ester for use in the present invention is obtained from at least one kind of an aliphatic diol having an average carbon number of 2.0 to 2.5 and a mixture (a dicarboxylic acid having an average carbon number of 6.0 to 10.0) of at least one kind of an aromatic ring-containing dicarboxylic acid (sometimes referred to as an aromatic dicarboxylic acid) and at least one kind of an aliphatic dicarboxylic acid.

The average carbon number is calculated individually for each of the dicarboxylic acid and the diol.

The value calculated by multiplying the number of constituent carbons by the compositional ratio (molar fraction) of the dicarboxylic acid is defined as the average carbon number (for example, when the dicarboxylic acid is composed of 50 mol % of adipic acid and 50 mol % of phthalic acid, the average carbon number is 7.0). The same applies to the diol and, for example, when the diol is composed of 50 mol % of ethylene glycol and 50 mol % of 1,2-propanediol, the average carbon number is 2.5.

The number average molecular weight of the polycondensed ester is preferably from 700 to 2,000, more preferably from 800 to 1,500, still more preferably from 900 to 1,200.

The number average molecular weight of the polycondensed ester for use in the present invention can be measured and evaluated by gel permeation chromatography. In the case of a polyester polyol with an uncapped terminal end, the number average molecular weight can also be calculated from the amount of hydroxyl group per weight (hereinafter referred as a hydroxyl number). The hydroxyl number is determined by acetylating a polyester polyol and then measuring the amount (mg) of potassium hydroxide necessary to neutralize excess acetic acid.

The dicarboxylic acid for use in the present invention as a mixture of an aromatic dicarboxylic acid and an aliphatic dicarboxylic acid is a dicarboxylic acid having an average carbon number of 6.0 to 10.0. If the average carbon number is less than 6, the polarizing plate is insufficient in terms of change in performance and the water permeability decreases with aging of the film, whereas if the average carbon number exceeds 10, the compatibility with a cellulose ester is deteriorated and bleed-out is generated in the process of producing the film.

As for the aromatic dicarboxylic acid, phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, 2,6-naphthalenedicarboxylic acid and the like are preferably used, and phthalic acid and terephthalic acid are more preferred.

In the case of using phthalic acid, terephthalic acid or isophthalic acid, the average carbon number of the mixed dicarboxylic acid is preferably from 6 to 7.5, more preferably from 6.5 to 7. In the case of naphthalene dicarboxylic acid, the average carbon number of the mixed dicarboxylic acid is preferably from 6.5 to 10, more preferably from 6.5 to 9.0.

One kind of an aromatic dicarboxylic acid or two or more kinds of aromatic dicarboxylic acids may be used, and in the case of using two kinds of aromatic dicarboxylic acids, it is preferred to use phthalic acid and terephthalic acid.

Examples of the aliphatic dicarboxylic acid that is preferably used in the present invention include oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid, with succinic acid and adipic acid being preferred. Also, one kind of an aliphatic dicarboxylic acid or two or more kinds of aliphatic dicarboxylic acids may be used, and in the case of using two kinds of aliphatic dicarboxylic acids, it is preferred to use succinic acid and adipic acid.

The diol forming the polycondensed ester is a mixed diol having an average carbon number of 2.0 to 2.5. If the average carbon number of the aliphatic diol exceeds 2.5, the loss on heating of the compound is increased, and a surface failure considered to be attributable to process contamination at the drying of a cellulose acylate web is caused, whereas if the average carbon number of the aliphatic diol is less than 2.0, the synthesis becomes difficult and therefore, this range cannot be used.

The aliphatic diol includes alkyl diols and alicyclic diols, and examples thereof include ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol and diethylene glycol. One kind of or a mixture of two or more kinds of these aliphatic diols is preferably used together with ethanediol.

Among these aliphatic diols, ethanediol, 1,2-propanediol and 1,3-propanediol are preferred, and ethanediol is more preferred.

As for the terminal structure of the polycondensed ester, a polyester polyol with the terminal end being a diol residue structure is preferred, or the terminal end of the polycondensed ester is preferably an ester-forming derivative of an aliphatic monocarboxylic acid having a carbon number of 3 or less. It is more preferred that the terminal end of the polycondensed ester is an ester-forming derivative of acetic acid or propionic acid.

The terminal end of the polycondensed ester for use in the present invention may remain as a diol residue structure without being capped, or so-called end capping may be performed by further reacting the polycondensed ester with monocarboxylic acids or monoalcohols.

Preferred examples of the monocarboxylic acid used for capping include acetic acid, propionic acid and butenoic acid. Among these, acetic acid and propionic acid are more preferred, and acetic acid is most preferred. Preferred examples of the monoalcohols used for capping include methanol, ethanol, propanol, isopropanol, butanol and isobutanol, with methanol being most preferred. When the carbon number of monocarboxylic acids used for the terminal end of the polycondensed ester is 3 or less, the loss on heating of the compound is not increased and no surface failure is caused.

The terminal end of the polycondensed ester for use in the present invention more preferably remains as a diol residue structure without being capped or is capped with acetic acid or propionic acid, and it is most preferred that the terminal end is formed into an acetyl ester residue structure by acetic acid capping.

### (Specific Examples of Polycondensed Ester)

Specific examples of the polycondensed ester for use in the present invention are set forth in Table 1, but the present invention is not limited thereto.

TABLE 1

| | Dicarboxylic Acid ^{*1)} | | | | | | | | |
|---|---|---|---|---|---|---|---|---|---|
| | | | | Average | Diol | | | | |
| | | Ali- | | Carbon | | | Average | | |
| | Aromatic | phatic | Ratio of | Number of | | Ratio | Carbon | | Number |
| | Dicar- | Dicar- | Dicarbox- | Dicar- | | of | Number of | | Average |
| | boxylic | boxylic | ylic Acids | boxylic | | Diols | Aliphatic | | Molecular |
| | acid | acid | (mol %) | Acid | Aliphatic Diol | (mol %) | Diol | Terminal End | Weight |
| P-1 | PA | AA | 25/75 | 6.5 | ethanediol | 100 | 2.0 | diol residue structure | 1000 |
| P-2 | PA | AA | 50/50 | 7.0 | ethanediol | 100 | 2.0 | diol residue structure | 1000 |
| P-3 | PA | AA | 75/25 | 7.5 | ethanediol | 100 | 2.0 | diol residue structure | 1000 |
| P-4 | PA | AA/SA | 60/20/20 | 6.8 | ethanediol | 100 | 2.0 | diol residue structure | 1000 |
| P-5 | PA | SA | 50/50 | 6.0 | ethanediol | 100 | 2.0 | diol residue structure | 1000 |
| P-6 | PA | SA | 80/20 | 7.2 | ethanediol | 100 | 2.0 | diol residue structure | 1000 |
| P-7 | TPA | AA | 15/85 | 6.3 | ethanediol | 100 | 2.0 | diol residue structure | 1000 |
| P-8 | TPA | AA | 50/50 | 7.0 | ethanediol | 100 | 2.0 | diol residue structure | 1000 |
| P-9 | TPA | AA | 75/25 | 7.5 | ethanediol | 100 | 2.0 | diol residue structure | 1000 |
| P-10 | TPA | AA/SA | 60/20/20 | 6.8 | ethanediol | 100 | 2.0 | diol residue structure | 1000 |
| P-11 | TPA | SA | 50/50 | 6.0 | ethanediol | 100 | 2.0 | diol residue structure | 1000 |
| P-12 | TPA | SA | 80/20 | 7.2 | ethanediol | 100 | 2.0 | diol residue structure | 1000 |
| P-13 | TPA/PA | AA | 25/25/50 | 7.0 | ethanediol | 100 | 2.0 | diol residue structure | 1000 |
| P-14 | TPA/PA | AA | 17/17/66 | 6.7 | ethanediol | 100 | 2.0 | diol residue structure | 1000 |
| P-15 | TPA/PA | AA/SA | 25/25/25/25 | 6.5 | ethanediol | 100 | 2.0 | diol residue structure | 1000 |
| P-16 | TPA/PA | AA | 25/25/50 | 7.0 | ethanediol/1,2- | 50/50 | 2.5 | diol residue structure | 1000 |
| | | | | | propanediol | | | | |
| P-17 | TPA/PA | AA | 25/25/50 | 7.0 | ethanediol | 100 | 2.0 | acetyl ester residue | 1000 |
| | | | | | | | | structure | |
| P-18 | TPA/PA | AA | 17/17/66 | 6.7 | ethanediol | I00 | 2.0 | acetyl ester residue | 1000 |
| | | | | | | | | structure | |
| P-19 | TPA/PA | AA/SA | 25/25/25/25 | 6.5 | ethanediol | 100 | 2.0 | acetyl ester residue | 1000 |
| | | | | | | | | structure | |
| P-20 | TPA/PA | AA | 25/25/50 | 7.0 | ethanediol | 100 | 2.0 | acetyl ester residue | 700 |
| | | | | | | | | structure | |
| P-21 | TPA/PA | AA | 25/25/50 | 7.0 | ethanediol | 100 | 2.0 | acetyl ester residue | 850 |
| | | | | | | | | structure | |
| P-22 | TPA/PA | AA | 25/25/50 | 7.0 | ethanediol | 100 | 2.0 | acetyl ester residue | 1200 |
| | | | | | | | | structure | |
| P-23 | TPA/PA | AA | 25/25/50 | 7.0 | ethanediol | 100 | 2.0 | acetyl ester residue | 1500 |
| | | | | | | | | structure | |
| P-24 | TPA/PA | AA | 25/25/50 | 7.0 | ethanediol | 100 | 2.0 | acetyl ester residue | 1800 |
| | | | | | | | | structure | |
| P-25 | TPA/PA | AA | 25/25/50 | 7.0 | ethanediol | 100 | 2.0 | propionyl ester | 1000 |
| | | | | | | | | residue structure | |
| P-26 | IPA | AA | 50/50 | 7.0 | ethanediol | 100 | 2.0 | diol residue structure | 1000 |
| P-27 | IPA | SA | 60/40 | 6.4 | ethanediol | 100 | 2.0 | diol residue structure | 1000 |
| P-28 | 2,6-NPA | AA/SA | 40/30/30 | 7.8 | ethanediol | 100 | 2.0 | diol residue structure | 1200 |
| P-29 | 1,5-NPA | AA/SA | 40/30/30 | 7.8 | ethanediol | 100 | 2.0 | diol residue structure | 1200 |
| P-30 | 1,4-NPA | AA/SA | 40/30/30 | 7.8 | ethanediol | 100 | 2.0 | diol residue structure | 1200 |
| P-31 | 1,8-NPA | AA/SA | 40/30/30 | 7.8 | ethanediol | 100 | 2.0 | diol residue structure | 1200 |
| P-32 | 2,8-NPA | AA/SA | 40/30/30 | 7.8 | ethanediol | 100 | 2.0 | diol residue structure | 1200 |
| P-33 | TPA/PA | AA | 25/25/50 | 7.0 | ethanediol | 100 | 2.0 | acetyl ester residue | 650 |
| | | | | | | | | structure | |
| P-34 | TPA/PA | AA | 25/25/50 | 7.0 | ethanediol | 100 | 2.0 | acetyl ester residue | 2200 |
| | | | | | | | | structure | |
| P-35 | TPA/PA | AA | 25/25/50 | 7.0 | ethanediol | 100 | 2.0 | benzoic ester residue | 1000 |
| | | | | | | | | structure | |
| P-36 | TPA/PA | AA | 25/25/50 | 7.0 | ethanediol | 100 | 2.0 | butyryl ester residue | 1000 |
| | | | | | | | | structure | |
| P-37 | TPA/PA | AA | 25/25/50 | 7.0 | ethanediol | 100 | 2.0 | 2-ethylhexyl ester | 1000 |
| | | | | | | | | residue structure | |
| P-38 | PA | AA | 67/33 | 10.0 | ethanediol | 100 | 2.0 | diol ester residue | 1000 |
| | | | | | | | | structure | |
| P-41 | TPA/PA | AA/SA | 45/5/25/25 | 6.5 | ethanediol | 100 | 2.0 | acetyl ester residue | 850 |
| | | | | | | | | structure | |
| P-42 | TPA/PA | AA | 45/5/50 | 7.0 | ethanediol | 100 | 2.0 | acetyl ester residue | 850 |
| | | | | | | | | structure | |

^{*1)} PA: phthalic acid,
TPA: terephthalic acid,
IPA: isophthalic acid,
AA: adipic acid,
SA: succinic acid,
2,6-NPA: 2,6-naphthalenedicarboxylic acid,
2,8-NPA: 2,8-naphthalenedicarboxylic acid,
1,5-NPA: 1,5-naphthalenedicarboxylic acid,
1,4-NPA: 1,4-naphthalenedicarboxylic acid,
1,8-NPA: 1,8-naphthalenedicarboxylic acid

As to the synthesis of the polycondensed ester for use in the present invention, the polycondensed ester can be easily synthesized in a usual manner either by a heat-melting condensation method using a polyesterification or transesterification reaction of the dicarboxylic acid, the diol and, if desired, a monocarboxylic acid or monoalcohol for end capping or by an interfacial condensation reaction of acid chlorides of these acids with glycols. Details of these polyester-based plasticizers are described in Koichi Murai (compiler), Kaso-zai Sono Riron to Oyo (Plasticizers, and Theory and Application Thereof) (Saiwai Shobo, 1st edition, published on Mar. 1, 1973). Furthermore, the materials described, for example, in JP-A-05-155809, JP-A-05-155810, JP-A-05-197073, JP-A-2006-259494, JP-A-07-330670, JP-A-2006-342227 and JP-A-2007-003679 can also be used.

The amount added of the polycondensed ester for use in the present invention is preferably from 0.1 to 25 massa, more preferably from 1 to 20 mass %, and most preferably from 3 to 15 mass %, based on the amount of the cellulose ester.

The content of the aliphatic diol, dicarboxylic acid ester or diol ester as the raw material contained in the polycondensed film for use in the present invention is preferably less than 1 mass %, more preferably less than 0.5 mass %, based on the cellulose ester film. Examples of the dicarboxylic acid ester include dimethyl phthalate, di(hydroxyethyl)phthalate, dimethyl terephthalate, di(hydroxyethyl)terephthalate, di(hydroxyethyl)adipate and di(hydroxyethyl)succinate. Examples of the diol ester include ethylene diacetate and propylene diacetate.

The cellulose ester film of the present invention preferably contains a compound having at least two or more aromatic rings.

The compound having at least two or more aromatic rings is described below.

The compound having at least two or more aromatic rings preferably shows a uniaxial optical property when uniformly aligned.

The molecular weight of the compound having at least two or more aromatic rings is preferably from 300 to 1,200, and more preferably from 400 to 1,000.

Examples of the compound having at least two aromatic rings include the triazine compounds described in JP-A-2003-344655, the rod-like compounds described in JP-A-2002-363343, and the liquid crystalline compounds described in JP-A-2005-134884 and JP-A-2007-119737. The compound is preferably the above-described triazine compound or rod-like compound. As for the compound having at least two aromatic rings, two or more kinds of compounds may also be used in combination.

The amount added of the compound having at least two aromatic rings is preferably from 0.05 to 10%, more preferably from 0.5 to 8%, still more preferably from 1 to 5%, in terms of the mass ratio to the cellulose ester.

The cellulose ester film which can be used for a retardation film, a polarizing plate and the like is described in detail below.

### [Cellulose Ester]

The cellulose ester includes a cellulose ester compound and an ester-substituted cellulose structure-containing compound obtained by biologically or chemically introducing a functional group into raw material cellulose. Incidentally, the cellulose ester film of the present invention preferably contains the above-described cellulose ester as the main component. The “main component” as used herein indicates, when the film is formed of a single polymer, the polymer itself, and when the film is formed of different polymers, the polymer having a highest mass fraction out of constituent polymers.

The cellulose ester described above is an ester of cellulose and an acid. The acid constituting the ester is preferably an organic acid, more preferably a carboxylic acid, still more preferably a fatty acid having a carbon number of 2 to 22, and most preferably cellulose acylate that is a lower fatty acid having a carbon number of 2 to 4.

### [Raw Material Cotton for Cellulose Acylate]

Examples of the cellulose as the raw material of cellulose acylate for use in the present invention include cotton linter and wood pulp (e.g., hardwood pulp, softwood pulp). A cellulose acylate obtained from any raw material cellulose can be used and depending on the case, a mixture thereof may be used. These raw material celluloses are described in detail, for example, in Marusawa and Uda, Plastic Zairyo Koza (17), Senni-kei Jushi (Plastic Material Lecture (17), Fiber-Based Resin), Nikkan Kogyo Shinbun Sha (1970), and JIII Journal of Technical Disclosure, No. 2001-1745, pp. 7-8, and celluloses described therein can be used and are not particularly limited in thier application to the cellulose acylate film of the present invention.

### [Substitution Degree of Cellulose Acylate]

The cellulose acylate suitable for the present invention, produced using the above-described cellulose as the raw material, is described below.

The cellulose acylate for use in the present invention is a cellulose whose hydroxyl group is acylated, and the substituent may be any acyl group from an acyl group having a carbon number of 2 to an acetyl group having a carbon number of 22. In the cellulose acylate for use in the present invention, the substitution degree on the hydroxyl group of cellulose is not particularly limited.

The substitution degree can be determined by calculation after measuring the bonding degree of an acetic acid and/or a fatty acid having a carbon number of 3 to 22, substituted on the hydroxyl group of cellulose. As for the measuring method, the measurement can be performed according to ASTM D817-91.

As described above, the substitution degree on the hydroxyl group of cellulose is not particularly limited, but the acyl substitution degree on the hydroxyl group of cellulose is preferably from 2.00 to 2.95.

Out of the acetic acid and/or fatty acid having a carbon number of 3 to 22 substituted on the hydroxyl group of cellulose, the acyl group having a carbon number of 2 to is not particularly limited and may be an aliphatic group or an allyl group or may be a single acyl group or a mixture of two or more kinds of acyl groups. Examples thereof include an alkylcarbonyl ester of cellulose, an alkenylcarbonyl ester of cellulose, an aromatic carbonyl ester of cellulose, and an aromatic alkylcarbonyl ester of cellulose, and these esters may have a further substituted group. Preferred examples of the acyl group include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadedanoyl group, an octadecanoyl group, an i-butanoyl group, a tert-butanoyl group, a cyclohexanecarbonyl group, an oleoyl group, a benzoyl group, a naphthylcarbonyl group and a cinnamoyl group. Among these, preferred are acetyl, propionyl, butanoyl, dodecanoyl, octadecanoyl, tert-butanoyl, oleoyl, benzoyl, naphthylcarbonyl and cinnamoyl, more preferred are acetyl, propionyl and butanoyl, and most preferred is an acetyl group.

In the case where the acyl substituent substituted on the hydroxyl group of cellulose is substantially composed of at least two kinds of acyl groups selected from an acetyl group/a propionyl group/a butanoyl group, the entire substitution degree thereof is preferably from 2.50 to 2.95. The acyl substitution degree is more preferably from 2.60 to 2.95, still more preferably from 2.65 to 2.95.

In the case where the acyl substituent of the cellulose acylate is only an acetyl group, the entire substitution degree thereof is preferably from 2.00 to 2.95. The substitution degree is more preferably from 2.40 to 2.95, still more preferably from 2.85 to 2.95.

### [Polymerization Degree of Cellulose Acylate]

The polymerization degree of the cellulose acylate for use in the present invention is, in terms of the viscosity average polymerization degree, preferably from 180 to 700 and in the case of cellulose acetate, more preferably from 180 to 550, still more preferably from 180 to 400, yet still more preferably from 180 to 350. When the polymerization degree is not more than the upper limit above, the viscosity of the dope solution of cellulose acylate is not excessively increased and the production of a film by casting is advantageously facilitated. When the polymerization degree is not less than the lower limit above, there arises no trouble such as decrease in the strength of the film produced, and this is preferred. The average polymerization degree can be measured according to the intrinsic viscosity method by Uda, et al. {Kazuo Uda and Hideo Saito, Journal of the Society of Fiber Science and Technology, Japan, Vol. 18, No. 1, pp. 105-120 (1962)}. This method is described in detail also in JP-A-9-95538.

The molecular weight distribution of the cellulose acylate preferably used in the present invention is evaluated by gal permeation chromatography, and it is preferred that the polydispersity index Mw/Mn (Mw is the mass average molecular weight and Mn is the number average molecular weight) is small and the molecular weight distribution is narrow. Specifically, the Mw/Mn value is preferably from 1.0 to 4.0, more preferably from 2.0 to 4.0, and most preferably from 2.3 to 3.4.

### [Production of Cellulose Acylate Film]

The cellulose acylate film of the present invention is produced by a solvent casting method. In the solvent casting method, the film is produced using a solution (dope) prepared by dissolving cellulose acylate in an organic solvent.

The organic solvent preferably contains a solvent selected from an ether having a carbon number of 3 to 12, a ketone having a carbon number of 3 to 12, an ester having a carbon number of 3 to 12, and a halogenated hydrocarbon having a carbon number of 1 to 6.

The ether, ketone and ester may have a cyclic structure. A compound having any two or more functional groups of an ester, a ketone and an ether (that is, —O—, —CO— and —COO—) may also be used as the organic solvent. The organic solvent may have other functional groups such as alcoholic hydroxyl group. In the case of an organic solvent having two or more kinds of functional groups, the number of carbon atoms preferably falls within the range of the carbon number specified for the solvent having any of those functional groups.

Examples of the ethers having a carbon number of 3 to 12 include diisopropyl ether, dimethoxymethane, dimethoxyethane, 1,4-dioxane, 1,3-dioxolan, tetrahydrofuran, anisole and phenetole.

Examples of the ketones having a carbon number of 3 to 12 include acetone, methyl ethyl ketone, diethyl ketone, diisobutyl ketone, cyclohexanone and methylcyclohexanone.

Examples of the esters having a carbon number of 3 to 12 include ethyl formate, propyl formate, pentyl formate, methyl acetate, ethyl acetate and pentyl acetate.

Examples of the organic solvent having two or more kinds of functional groups include 2-ethoxyethyl acetate, 2-methoxyethanol and 2-butoxyethanol.

The carbon number of the halogenated hydrocarbon is preferably 1 or 2, and most preferably 1. The halogen of the halogenated hydrocarbon is preferably chlorine. The ratio of a halogen substituting for hydrogen atom of the halogenated hydrocarbon is preferably from 25 to 75 mol %, more preferably from 30 to 70 mol %, still more preferably from 35 to 65 mol %, and most preferably from 40 to 60 mol %. Methylene chloride is a representative halogenated hydrocarbon.

Two or more kinds of organic solvents may be mixed and used.

The cellulose acylate solution can be prepared by a general method of performing the treatment at a temperature of 0° C. or more (ordinary temperature or high temperature). The preparation of the solution can be performed using the method and apparatus for preparing a dope in a usual solvent casting method. In the case of a general method, a halogenated hydrocarbon (in particular, methylene chloride) is preferably used as the organic solvent.

The cellulose acylate solution is prepared such that the cellulose acylate is contained in an amount of 10 to 40 mass % in the obtained solution. The amount of the cellulose acylate is more preferably from 10 to 30 mass %. In the organic solvent (main solvent), arbitrary additives described later may be added.

The solution can be prepared by stirring the cellulose acylate and the organic solvent at ordinary temperature (from 0 to 40° C.). A high-concentration solution may be stirred under pressure and heating conditions. Specifically, the cellulose acetate and the organic solvent are put in a pressure vessel and hermetically sealed, and the mixture is stirred under pressure while heating at a temperature that is not lower than the boiling point of the solvent at ordinary temperature and causes no boiling of the solvent.

The heating temperature is usually 40° C. or more, preferably from 60 to 200° C., more preferably from 80 to 110° C.

Respective components may be coarsely mixed in advance and put in the vessel or may be sequentially charged into the vessel. The vessel needs to be configured to allow for stirring. The vessel can be pressurized by injecting an inert gas such as nitrogen gas. Also, a rise in the vapor pressure of the solvent due to heating may be utilized. Alternatively, after hermetically closing the vessel, respective components may be added under pressure.

In the case of applying heating, the mixture is preferably heated from the outside of the vessel. For example, a jacket-type heating apparatus can be used. It is also possible to heat the entire vessel by providing a plate heater on the outside of the vessel, laying a pipe and circulating a liquid thereinto.

A stirring blade is preferably provided in the inside of the vessel to perform the stirring by using it. A stirring blade having a length long enough to reach the vicinity of the vessel wall is preferred. At the end of the stirring blade, a scraping blade is preferably provided so as to renew the liquid film on the vessel wall.

The vessel may be provided with measuring instruments such as pressure gauge and thermometer. In the vessel, respective components are dissolved in a solvent. The prepared dope is cooled and then taken out from the vessel or is taken out from the vessel and then cooled by using a heat exchanger or the like.

The cellulose acylate film is produced from the prepared cellulose acylate solution (dope) by a solvent casting method. The above-described retardation raising agent is preferably added to the dope.

The dope is cast on a drum or a band, and the solvent is evaporated to form a film. The concentration of the dope before casting is preferably adjusted to a solid content of 18 to 35%. The surface of the drum or band is preferably mirror-finished, and the dope is preferably cast on the drum or band whose surface temperature is 10° C. or less.

In the present invention, when casting the dope (cellulose acylate solution) on a band, in the first half of drying before stripping, a substantially airless drying is performed for 10 to 90 seconds, preferably from 15 to 90 seconds. Also, when casting the dope on a drum, in the first half of drying before stripping, a substantially airless drying is performed for 1 to 10 seconds, preferably from 2 to 5 seconds.

In the present invention, the term “drying before stripping” indicates drying from coating of the dope on the band or drum to stripping as a film. Also, the term “first half” indicates a step before a half of the total time required from coating of the dope to stripping. The term “substantially airless” indicates that an air rate of 0.5 m/sec or more is not detected at a distance within 200 mm from the band surface or drum surface (that is, the air rate is less than 0.5 m/s).

The first half of drying before stripping is, on the band, usually a time period of approximately from 30 to 300 seconds and out of this time period, the airless drying is performed for 10 to 90 seconds, preferably from 15 to 90 seconds. The first half is, on the drum, usually a time period of approximately from 5 to 30 seconds and out of this time period, the airless drying is performed for 1 to 10 seconds, preferably from 2 to 5 seconds. The ambient temperature is preferably from 0 to 180° C., more preferably from 40 to 150° C. The operation of airless drying can be performed at any stage in the first half of drying before stripping but is preferably performed immediately after the casting. If the airless drying time is less than 10 seconds on the band (less than 1 second on the drum), it is difficult for the additives to uniformly distribute in the film, whereas if it exceeds 90 seconds (exceeds 10 seconds on the drum), the film is stripped in an insufficient drying state and the surface profile of the film is worsened.

Drying other than the airless drying time in the drying before stripping can be performed by blowing an inert gas. At this time, the air temperature is preferably from 0 to 180° C., more preferably from 40 to 150° C.

The drying method in the solvent casting method is disclosed in U.S. Pat. Nos. 2,336,310, 2,367,603, 2,492,078, 2,492,977, 2,492,978, 2,607,704, 2,739,069 and 2,739,070, British Patents 640,731 and 736,892, JP-B-45-4554 (the term “JP-B” as used herein means an “examined Japanese patent publication”), JP-B-49-5614, JP-A-60-176834, JP-A-60-203430 and JP-A-62-115035. Drying on the band or drum can be performed by blowing an inert gas such as air and nitrogen.

The obtained film is stripped from the drum or band and can be further dried with high-temperature air by sequentially varying the temperature between 100° C. and 160° C. to evaporate the residual solvent. This method is described in JP-B-5-17844. According to this method, the time from casting to stripping can be shortened. For practicing this method, the dope needs to be gelled at the surface temperature of the drum or band during casting.

A film can also be formed using the prepared cellulose acylate solution (dope) by casting it in two or more layers. In this case, the cellulose acylate film is preferably produced by a solvent casting method. The dope is cast on a drum or a band, and the solvent is evaporated to form a film. The concentration of the dope before casting is preferably adjusted to a solid content of 10 to 40%. The surface of the drum or band is preferably mirror-finished.

In the case of casting a plurality of cellulose acylate solutions in two or more layers, a film may be produced by casing and stacking respective cellulose acylate-containing solutions from a plurality of casting nozzles allowed to cast a plurality of cellulose acylate solutions and provided at intervals in the support traveling direction. For example, the methods described in JP-A-61-158414, JP-A-1-122419 and JP-A-11-198285 can be employed. Furthermore, a film can also be formed by casting the cellulose acylate solution from two casting nozzles. For example, the methods described in JP-B-60-27562, JP-A-61-94724, JP-A-61-947245, JP7A-61-104813, JP-A-61-158413 and JP-A-6-134933 can be employed. In addition, the casting method described in JP-A-56-162617, where a flow of a high-viscosity cellulose acylate solution is encompassed by a low-viscosity cellulose acylate solution and the high-viscosity and low-viscosity cellulose acylate solutions are simultaneously extruded, can also be employed.

A film can also be produced using two casting nozzles by stripping a film formed on a support by means of a first casting nozzle and then performing second casting on the side that had been contacted with the support surface. Examples of this method include the method described in JP-B-44-20235.

As for the cellulose acylate solutions cast, the same solution may be used, or different cellulose solutions may be used. For imparting a function to a plurality of cellulose acylate layers, a cellulose acylate solution appropriate for the function may be extruded from each casting nozzle. Furthermore, the cellulose acylate solution of the present invention can be cast simultaneously with other functional layers (for example, an adhesion layer, a dye layer, an antistatic layer, an antihalation layer, an ultraviolet absorbent layer and a polarizing layer).

In the case of a conventional single-layer solution, a cellulose acylate solution having a high viscosity and a high concentration must be extruded so as to obtain a required film thickness. In this case, the cellulose acylate solution has bad stability and often causes generation of a solid material that gives rise to a problem such as solid failure or planarity defect. For solving this problem, a plurality of cellulose acylate solutions are cast from casting nozzles, whereby not only high-viscosity solutions can be simultaneously extruded on a support and a film with improved planarity and excellent surface profile can be produced but also thanks to use of a thick cellulose acylate solution, reduction in the drying load can be achieved and the film production speed can be increased.

The width of the cellulose ester film of the present invention is preferably from 0.5 to 5 m, more preferably from 0.7 to 3 m. The winding length of the film is preferably from 300 to 30,000 m, more preferably from 500 to 10,000 m, still more preferably from 1,000 to 7,000 m.

### (Film Thickness)

The film thickness of the cellulose ester film of the present invention is preferably from 20 to 180 μm, more preferably from 30 to 160 μl, still more preferably from 40 to 120 μm. When the film thickness is 20 μm or more, this is preferred in view of handleability during processing into a polarizing plate or the like and curl inhibition of the polarizing plate. Also, the thickness unevenness of the cellulose ester film of the present invention is, in both the conveying direction and the width direction, preferably from 0 to 2%, more preferably from 0 to 1.5%, still more preferably from 0 to 1%.

### (Additives)

In the cellulose acylate film, a deterioration inhibitor (e.g., antioxidant, peroxide decomposer, radical inhibitor, metal deactivator, acid scavenger, amine) may be added. The deterioration inhibitor is described in JP-A-3-199201, JP-A-5-1907073, JP-A-5-194789, JP-A-5-271471 and JP-A-6-107854. In view of bringing out the effect and preventing the deterioration inhibitor from bleeding out (bleed-out) to the film surface, the amount added of the deterioration inhibitor is preferably from 0.01 to 1 mass %, more preferably from 0.01 to 0.2 mass %, based on the solution (dope) prepared.

Examples of the particularly preferred deterioration inhibitor include butylated hydroxytoluene (BHT) and tribenzylamine (TBA).

In the present invention, an ultraviolet absorber may be added. As the ultraviolet absorber, the compounds (benzophenone, benzotriazole, triazine) described in JP-A-2006-282979 are preferably used. Also, two or more kinds of ultraviolet absorbers can be used in combination.

The ultraviolet absorber is preferably benzotriazole, and specific examples thereof include TINUVIN 328, TINUVIN 326, TINUVIN 329, TINUVIN 571 and ADEKASTAB LA-31.

The amount used of the ultraviolet absorber is preferably 10% or less, more preferably 3% or less, and most preferably from 0.05 to 2%, in terms of the mass ratio to the cellulose ester.

### (Fine Matting Agent Particle)

The cellulose ester film of the present invention preferably contains a fine particle as a matting agent. Examples of the fine particle for use in the present invention include silicon dioxide, titanium dioxide, aluminum oxide, zirconium oxide, calcium carbonate, calcium carbonate, talc, clay, calcined kaolin, calcined calcium silicate, hydrated calcium silicate, aluminum silicate, magnesium silicate and calcium phosphate. The fine particle is preferably a silicon-containing fine particle because of low turbidity, more preferably silicon dioxide. The fine silicon dioxide particle is preferably a fine particle having a primary average particle diameter of 20 nm or less and an apparent specific gravity of 70 g/L or more. A fine particle having as a small average primary particle diameter as from 5 to 16 nm is more preferred because the haze of the film can be reduced. The apparent specific gravity is preferably from 90 to 200 g/L, more preferably from 100 to 200 g/L. A larger apparent specific gravity is preferred, because a liquid dispersion with a high concentration can be prepared and the haze and aggregate are improved.

The fine particle usually forms a secondary particle having an average particle diameter of 0.1 to 3.0 μm and in the film, this particle is present as an aggregate of primary particles to produce unevenness of 0.1 to 3.0 μm on the film surface. The average secondary particle diameter is preferably from 0.2 to 1.5 μm, more preferably from 0.4 to 1.2 μm, and most preferably from 0.6 to 1.1 μm. As for the primary and secondary particle diameters, particles in the film are observed through a scanning electron microscope and the diameter of a circle circumscribing a particle is defined as the particle diameter. Also, 200 particles are observed by changing the site, and the average value thereof is defined as the average particle diameter.

The fine silicon dioxide particle used may be a commercially available product such as “Aerosil R972”, “Aerosil R972V”, “Aerosil R974”, “Aerosil R812”, “Aerosil 200”, “Aerosil 200V”, “Aerosil 300”, “Aerosil R202”, “Aerosil OX50” and “Aerosil TT600” {all produced by Nihon Aerosil Co., Ltd.}. The fine zirconium oxide particle is commercially available under the trade name of, for example, “Aerosil R976” or “Aerosil R811” {both produced by Nihon Aerosil Co., Ltd.}, and these may be used.

Among these fine particles, “Aerosil 200V” and “Aerosil R972V” are preferred, because they are a fine silicon dioxide particle having an average primary particle diameter of 20 nm or less and an apparent specific gravity of 70 g/L or more and provide a high effect of decreasing the coefficient of friction while maintaining low turbidity of the optical film.

In the present invention, in order to obtain a cellulose ester film containing particles having a small average secondary particle diameter, several techniques may be considered at the preparation of a liquid dispersion of fine particles. For example, there is known a method where a solvent and fine particles are mixed with stirring to previously prepare a liquid dispersion of fine particles, the obtained liquid dispersion of fine particles is added to a small amount of a separately prepared cellulose ester solution and dissolved with stirring, and the resulting solution is further mixed with a main cellulose ester dope solution. This method is a preferred preparation method in that good dispersibility of fine silicone dioxide particles is ensured and re-aggregation of fine silicon dioxide particles scarcely occurs. In addition, there is known a method where a small amount of a cellulose ester is added to a solvent and dissolved with stirring, fine particles are added thereto and dispersed by a disperser to obtain a fine particle-added solution, and the fine particle-added solution is thoroughly mixed with a dope solution by an in-line mixer. The present invention is not limited to these methods, but at the time of mixing and dispersing fine silicon dioxide particles with a solvent or the like, the concentration of silicon dioxide is preferably from 5 to 30 mass %, more preferably from 10 to 25 mass %, and most preferably from 15 to 20 mass %. A higher dispersion concentration is preferred, because the liquid turbidity for the amount added becomes low and the haze and aggregate are improved. In the final dope solution of cellulose acylate, the amount of the matting agent added is preferably from 0.01 to 1.0 g/m², more preferably from 0.03 to 0.3 g/m², and most preferably from 0.08 to 0.16 g/m².

As for the solvent used here, preferred examples of the lower alcohols include methyl alcohol, ethyl alcohol, propyl alcohol, isopropyl alcohol and butyl alcohol. The solvent other than the lower alcohol is not particularly limited, but it is preferred to use the solvent that is used at the formation of cellulose ester into a film.

### [Stretching]

In the cellulose ester film of the present invention, the retardation can be adjusted by a stretching treatment. A method of positively stretching the film in a width direction is described, for example, in JP-A-62-115035, JP-A-4-152125, JP-A-4-284211, JP-A-4-298310 and JP-A-11-48271. Stretching of the film is performed under an ordinary temperature or heating condition. The heating temperature is preferably within ±20° C. of the glass transition temperature of the film. If the film is stretched at a temperature extremely lower than the glass transition temperature, the film is liable to be ruptured and cannot exhibit desired optical properties. Also, if the film is stretched at a temperature extremely higher than the glass transition temperature, the molecules aligned by the stretching are, still in a thermally unfixed state, relaxed due to heat at the stretching and the alignment cannot be fixed, giving rise to bad expression of optical properties.

Furthermore, in a stretching zone (for example, a tenter zone), after the film is engaged, conveyed and stretched at a maximum width expansion ratio, a zone for relaxing the film is usually provided. This is a zone necessary for reducing the axial shifting. In usual stretching, the time that the film takes to pass through this relaxation rate zone after stretching at a maximum width expansion ratio until it exits from the tenter zone is shorter than 1 minute. The stretching of the film may be uniaxial stretching only in the conveying direction or in the width direction or may be simultaneous or sequential biaxial stretching, but the stretch ratio is preferably larger in the width direction. Stretching of 5 to 100% is preferred, and stretching of 5 to 80% is more preferred. Also, the stretching treatment may be performed on the way of the film formation step, or a stock film formed and rolled up may be subjected to a stretching treatment. In the former case, stretching may be performed in a state still containing a residual solvent amount, and the film can be preferably stretched when the residual solvent amount=(mass of residual volatile component)/(mass of film after heat treatment)×100% is from 0.05 to 50%. In particular, stretching of 1 to 80% in a state of the residual solvent amount being from 0.05 to 5% is preferred.

The cellulose ester film of the present invention may also be biaxially stretched.

The biaxial stretching includes a simultaneous biaxial stretching method and a sequential biaxial stretching method. In view of continuous production, a sequential biaxial stretching method is preferred, where after casting the dope, the film is stripped from the band or drum and stretched in the width direction (or longitudinal direction) and then in the longitudinal direction (or width direction).

The step from casting to post-drying may be performed in an air atmosphere or an inert gas atmosphere such as nitrogen gas. The winder for use in the production of the cellulose ester film of the present invention may be a generally employed winder, and the film can be rolled up by a winding method such as constant tension method, constant torque method, taper tension method and program tension control method with the internal stress being constant.

### [Retardation of Film]

In this specification, Re and Rth indicate the in-plane retardation and the retardation in a thickness direction at a wavelength of λ, respectively. Re is measured by making light at a wavelength of λnm incident in the normal direction of the film in KOBRA 21ADH (manufactured by Oji Scientific Instruments). Rth is computed by KOBRA 21ADH based on the retardation values measured in three directions in total, that is, the Re above, the retardation value measured by making light at a wavelength of λnm incident from the direction inclined at +40° with respect to the normal direction of the film by using the in-plane slow axis (determined by KOBRA 21ADH) as the tilt axis (rotation axis), and the retardation value measured by making light at a wavelength of λnm incident from the direction inclined at −40° with respect to the normal direction of the film by using the in-plane slow axis as the tilt axis (rotation axis). Here, the values described in Polymer Handbook (JOHN WILEY & SONS, INC.) and catalogues of various optical films can be used as the assumed value of the average refractive index. The average refractive index whose value is unknown can be measured by the Abbe refractometer. For example, values of average refractive index of major optical films are set forth below: cellulose acylate (1.48), cycloolefin polymer (1.52), polycarbonate (1.59), polymethyl methacrylate (1.49) and polystyrene (1.59). When the assumed average refractive index value and the film thickness are input, nx, ny, and nz are computed by KOBRA 21ADH, and Nz=(nx−nz)/(nx−ny) is further computed from these computed nx, ny and nz.

The cellulose ester film of the present invention is used as a protective film of a polarizing plate and in particular, can also be preferably used as a retardation film matching various liquid crystal modes.

In the case of using the cellulose ester film of the present invention as a retardation film, preferred optical properties of the cellulose ester film differ according to the liquid crystal mode.

For the VA mode, Re measured at a wavelength of 590 nm is preferably from 20 to 150 nm, more preferably from 50 to 130 nm, still more preferably from 70 to 120 nm, and Rth is preferably from 100 to 300 nm, more preferably from 120 to 280 nm, still more preferably from 150 to 250 nm.

For the TN mode, Re is preferably from 0 to 100 nm, more preferably from 20 to 90 nm, still more preferably from 50 to 80 nm, and Rth is preferably from 20 to 200 nm, more preferably from 30 to 150 nm, still more preferably from 40 to 120 nm.

For the TN mode, an optically anisotropic layer is coated on the cellulose ester film having the above-described retardation value, and the resulting film can be used as a retardation film.

### (Haze of Film)

The haze of the cellulose ester film of the present invention is preferably from 0.01 to 2.0%, more preferably from 0.05 to 1.5%, still more preferably from 0.1 to 1.0%. Transparency of the film is important as an optical film. The haze can be measured in accordance with JIS K-6714 by preparing a sample of 40 mm×80 mm from the cellulose ester film of the present invention and measuring it at 25° C. and 60% RH by means of a haze meter, “HGM-2DP” {manufactured by Suga Test Instruments Co., Ltd.}.

### (Spectral Characteristics and Spectral Transmittance)

A cellulose ester film sample of 13 mm×40 mm can be measured for the transmittance at a wavelength of 300 to 450 nm by using a spectrophotometer, “U-3210” {manufactured by Hitachi, Ltd.}, at 25° C. and 60% RH. The tilt width can be determined by wavelength for 72%−wavelength for 5%. The limiting wavelength can be expressed by the wavelength of (tilt width/2)+5%, and the absorption edge is expressed by the wavelength at a transmittance of 0.4%. From these, the transmittance at 380 nm or 350 nm can be evaluated.

In the cellulose ester film of the present invention, it is preferred that the spectral transmittance at a wavelength of 380 nm is from 45 to 95% and at the same time, the spectral transmittance at a wavelength of 350 nm is 10% or less.

### [Glass Transition Temperature]

The glass transition temperature of the cellulose ester film of the present invention is preferably 120° C. or more, more preferably 140° C. or more.

The glass transition temperature can be determined as an average value of a temperature causing the base line derived from the glass transition of the film to start changing and a temperature returning to the base line when measured at a temperature rise rate of 10° C./min by using a differential scanning calorimeter (DSC).

The glass transition temperature can also be determined using the following dynamic viscoelasticity measuring apparatus. A 5 mm×30 mm sample of the cellulose ester film (unstretched) of the present invention is humidity-conditioned at 25° C. and 60% RH for 2 hours or more and then measured by a dynamic viscoelasticity measuring apparatus (VIBRON: DVA225 (manufactured by IT Keisoku Seigyo K.K.)) at a chuck-to-chuck distance of 20 mm, a temperature rise rate of 2° C./rain, a measurement temperature of 30° C. to 250° C. and a frequency of 1 Hz. When the storage modulus is taken as a logarithmic axis on the ordinate and the temperature (° C.) is taken as a linear axis on the abscissa and when an abrupt reduction in the storage modulus which is observed in the process of the storage modulus transitioning from a solid region to a glass transition region is drawn as a straight line 1 in the solid region and drawn as a straight line 2 in the glass transition region, the intersection between the straight line 1 and the straight line 2 is a temperature at which the storage modulus abruptly decreases during temperature rise and the film starts softening, that is, a temperature at which the transition to the glass transition region starts, and therefore, this point is defined as a glass transition temperature Tg (dynamic viscoelasticity).

### (Moisture Permeability of Film)

The moisture permeability of the film is measured under the conditions of 60° C. and 95% RH in accordance with JIS Z-0208. The moisture permeability becomes smaller as the thickness of the cellulose ester film is larger, and the moisture permeability becomes larger as the film thickness is smaller. Accordingly, in the case of a sample differing in the thickness, the value needs to be converted by setting the basis to 80 μm. The film thickness can be converted according to the following mathematical formula:

Moisture permeability in terms of film thickness of 80μm=measured moisture permeability×measured film thickness (μm)/80 (μm) Mathematical Formula

As for the measuring method of moisture permeability, the methods described in “Measurement of Amount of Vapor Permeated (mass method, thermometer method, vapor pressure method, adsorption method)” of Kobunshi Jikken Koza 4, Kobunshi no Bussei II (Polymer Experiment Lecture 4, Physical Properties II of Polymers), pp. 285-294, Kyoritsu Shuppan, can be applied.

The moisture permeability of the cellulose ester film of the present invention is preferably from 400 to 2,000 g/m²⁰·24 hr, more preferably from 400 to 1,800 g/m²⁰·24 hr, still more preferably from 400 to 1,600 g/m²⁰·24 hr. When the moisture permeability is 2,000 g/m²⁰·24 hr or less, there is not caused a trouble such as the humidity dependency of Re value and Rth value of the film exceeding 0.5 nm/% RH in terms of the absolute value.

### (Configuration of Cellulose Ester Film)

The cellulose ester film of the present invention may be of a single layer structure or may be composed of a plurality of layers but is preferably of a single layer structure. The film of “a single layer structure” as used herein means a single sheet of cellulose ester film but not a sheet obtained by laminating together a plurality of film materials. This also includes a case of producing a single sheet of cellulose ester film from a plurality of cellulose ester solutions by using a sequential casting system or a co-casting system.

In this case, a cellulose ester film having a distribution in the thickness direction can be obtained by appropriately adjusting the kind or blending amount of additive, the molecular weight distribution of cellulose ester, or the kind or the like of cellulose ester. Also, the single sheet of film includes a film having therein various functional parts such as optically anisotropic part, antiglare part, gas barrier part and moisture resistant part.

### (Surface Treatment)

The adhesion of each functional layer (e.g., undercoat layer, back layer, optically anisotropic layer) can be improved by applying an appropriate surface treatment to the cellulose ester film of the present invention.

In order to improve the adhesion between the film surface and the functional layer, an undercoat layer (adhesion layer) can also be provided on the transparent cellulose ester film of the present invention, in addition to or in place of the surface treatment. The undercoat layer is described in JIII Journal of Technical Disclosure, No. 2001-1745, page 32, Japan Institute of Invention and Innovation (issued on Mar. 15, 2001), and the undercoat layers described therein can be appropriately used. Furthermore, the functional layer provided on the cellulose ester film is described in JIII Journal of Technical Disclosure, No. 2001-1745, pp. 32-45, Japan Institute of Invention and Innovation (published on Mar. 15, 2001), and the functional layers described therein can be appropriately used on the transparent cellulose ester film of the present invention.

### <<Retardation Film>>

The cellulose ester film of the present invention can be used as a retardation film. Incidentally, the “retardation film” means an optical material that is generally used in a display device such as liquid crystal display device and has optical anisotropy, and this term has the same meaning as a retardation plate, an optically compensatory film, an optically compensatory sheet or the like. In a liquid crystal display device, the retardation film is used for the purposes of enhancing the contrast of the display screen or improving the viewing angle characteristics or tint.

Use of the transparent cellulose ester film of the present invention enables facilitating the production of a retardation film whose Re value and Rth value are freely controlled.

Also, a plurality of the cellulose ester films of the present invention may be laminated, or the cellulose ester film of the present invention may be laminated with a film out of the scope of the present invention, thereby appropriately adjusting the Re or Rth, and the obtained film can be used as a retardation film.

Furthermore, depending on the case, the cellulose ester film of the present invention may be used as a support of the retardation film, and an optically anisotropic layer composed of a liquid crystalline compound or the like may be provided thereon, whereby the film can be used as a retardation film. The optically anisotropic layer applied to the retardation film of the present invention may be formed of, for example, a composition containing a liquid crystalline compound, a cellulose ester film having birefringence, or the cellulose ester film of the present invention.

The liquid crystalline compound above is preferably a discotic liquid crystalline compound or a rod-like liquid crystalline compound.

### [Discotic Liquid Crystalline Compound]

Examples of the discotic liquid crystalline compound usable as the liquid crystalline compound in the present invention include the compounds described in various publications (e.g., C. Destrade et al., Mol. Crysr. Liq. Cryst., Vol. 71, page 111 (1981); Kikan Kagaku Sosetsu (Quarterly Chemistry Survey), No. 22, “Ekisho no Kagaku (The Chemistry of Liquid Crystal)”, Chapter 5 and Chapter 10, Section 2, edited by Nippon Kagaku Kai (1994); B. Kohne et al., Angew. Chem. Soc. Chem. Comm., page 1794 (1985); J. Zhang et al., J. Am. Chem. Soc., Vol. 116, page 2655 (1994)).

In the optically anisotropic layer, discotic liquid crystalline molecules are preferably fixed in an aligned state and most preferably fixed by a polymerization reaction. Polymerization of discotic liquid crystalline molecules is described in JP-A-8-27284. In order to fix discotic liquid crystalline molecules by polymerization, a polymerizable group must be bonded as a substituent to the discotic core of a discotic liquid crystalline molecule. However, if a polymerizable group is bonded directly to the discotic core, the aligned state can be hardly maintained during the polymerization reaction. Therefore, a linking group is introduced between the discotic core and the polymerizable group. The discotic liquid crystalline molecule having a polymerizable group is disclosed in JP-A-2001-4387.

### [Rod-Like Liquid Crystalline Compound]

Examples of the rod-like liquid crystalline compound usable as the liquid crystalline compound in the present invention include azomethines, azoxys, cyanobiphenyls, cyanophenyl esters, benzoic acid esters, phenyl cyclohexanecarboxylates, cyanophenylcyclohexanes, cyano-substituted phenylpyrimidines, alkoxy-substituted phenylpyrimidines, phenyldioxanes, tolans and alkenylcyclohexylbenzonitriles. Not only these low-molecular liquid crystalline compounds but also a polymer liquid crystalline compound can be used as the rod-like liquid crystalline compound.

In the optically anisotropic layer, rod-like liquid crystalline molecules are preferably fixed in an aligned state and most preferably fixed by a polymerization reaction. Examples of the polymerizable rod-like liquid crystalline compound which can be used in the present invention include the compounds described in Makromol. Chem., Vol. 190, page 2255 (1989), Advanced Materials, Vol. 5, page 107 (1993), U.S. Pat. Nos. 4,683,327, 5,622,648 and 5,770,107, International Publication Nos. 95/22586 (pamphlet), 95/24455 (pamphlet), 97/00600 (pamphlet), 98/23580 (pamphlet) and 98/52905 (pamphlet), JP-A-1-272551, JP-A-6-16616, JP-A-7-110469, JP-A-11-80081 and JPA-2001-328973.

### <<Polarizing Plate>>

The cellulose ester film or retardation film of the present invention can be used as a protective film of a polarizing plate (the polarizing plate of the present invention). The polarizing plate of the present invention comprises a polarizing film and two polarizing plate protective films (transparent films) protecting both surfaces of the polarizing film, and the cellulose ester film or retardation film of the present invention can be used as at least one polarizing plate protective film.

In the case of using the cellulose ester film of the present invention as the polarizing plate protective film, the cellulose ester film of the present invention is preferably hydrophilized by applying the above-described surface treatment (described also in JP-A-6-94915 and JP-A-6-118232). For example, a glow discharge treatment, a corona discharge treatment or an alkali saponification treatment is preferably applied. In particular, when the cellulose ester constituting the cellulose ester film of the present invention is cellulose acylate, an alkali saponification treatment is most preferred as the surface treatment.

Also, for example, a film obtained by dipping a polyvinyl alcohol film in an iodine solution and stretching it can be used as the polarizing film. In the case of using a polarizing film obtained by dipping a polyvinyl alcohol film in an iodine solution and stretching it, the surface-treated surface of the transparent cellulose ester film of the present invention can be directly laminated to both surfaces of the polarizing film by using an adhesive. In the production method of the present invention, it is preferred that the cellulose ester film is directly laminated to the polarizing film. As for the adhesive, an aqueous solution of polyvinyl alcohol or polyvinyl acetal (e.g., polyvinyl butyral) or a latex of vinyl-based polymer (e.g., polybutyl acrylate) can be used. The particularly preferred adhesive is an aqueous solution of completely saponified polyvinyl alcohol.

In general, a liquid crystal cell is provided between two polarizing plates and therefore, a liquid crystal display device has four polarizing plate protective films. The cellulose ester film of the present invention may be used for any of four polarizing plate protective films, but the cellulose ester film of the present invention can be advantageously used particularly as a protective film disposed between the polarizing film and the liquid crystal layer (liquid crystal cell) in a liquid crystal display device. Also, a transparent hardcoat layer, an antiglare layer, an antireflection layer or the like can be provided for the protective film disposed on the side opposite the cellulose ester film of the present invention across the polarizing film. In particular, the cellulose ester film of the present invention is preferably used as a polarizing plate protective film of the outermost surface on the display side of a liquid crystal display device.

### <<Liquid Crystal Display Device>>

The cellulose ester film, retardation film and polarizing plate of the present invention can be used in liquid crystal display devices of various display modes. Each of the liquid crystal modes for which these films are used is described below. Out of these modes, the cellulose ester film, retardation film or polarizing plate of the present invention is preferably used particularly in a liquid crystal display device of VA mode or IPS mode. The liquid crystal display device may be any of a transmission type, a reflection type and a transflective type.

### (TN-Type Liquid Crystal Display Device)

The cellulose ester film of the present invention may be used as a support of a retardation film for a TN-type liquid crystal display device having a liquid crystal cell of TN mode. The liquid crystal cell of TN mode and the TN-type liquid crystal display device are well known from old. The retardation film for use in the TN-type liquid crystal display device is described in JP-A-3-9325, JP-A-6-148429, JP-A-8-50206, JP-A-9-26572 and the reports of Mori, et al. (Jpn. J. Appl. Phys., Vol. 36, page 143 (1997) and Jpn. J. Appl. Phys., Vol. 36, page 1068 (1997)).

### (STN-Type Liquid Crystal Display Device)

The cellulose ester film of the present invention may be used as a support of a retardation film for an STN-type liquid crystal display device having a liquid crystal cell of STN mode. In the STN-type liquid crystal display device, rod-like liquid crystalline molecules in the liquid crystal cell are generally twisted in the range of 90 to 360°, and the product (Δnd) of the refractive anisotropy (Δn) of the rod-like liquid crystalline molecule and the cell gap (d) is in the range of 300 to 1,500 nm. The retardation film for use in the STN-type liquid crystal display device is described in JP-A-2000-105316.

### (VA-Type Liquid Crystal Display Device)

The cellulose ester film of the present invention is advantageously used particularly as a retardation film or a support of a retardation film for a VA-type liquid crystal display device having a liquid crystal cell of VA mode. The VA-type liquid crystal display device may be of a multi-domain mode disclosed, for example, in JP-A-10-123576. In such an embodiment, the polarizing plate using the cellulose ester film of the present invention contributes to the enlargement of viewing angle and the improvement of contrast.

### (IPS-Type Liquid Crystal Display Device and ECB-Type Liquid Crystal Display Device)

The cellulose ester film of the present invention is advantageously used particularly as a retardation film, a support of a retardation film, or a protective film of a polarizing plate for an IPS-type liquid crystal display device or an ECB-type liquid crystal display device having a liquid crystal cell of IPS mode or ECB mode. These modes are an embodiment in which the liquid crystal material is aligned nearly in parallel at the time of black display, and the liquid crystal molecules are aligned in parallel to the substrate surface in the non-voltage applied state, thereby producing a black display. In such an embodiment, the polarizing plate using the cellulose ester film of the present invention contributes to the enlargement of viewing angle and the improvement of contrast.

### (OCB-Type Liquid Crystal Display Device and HAN-Type Liquid Crystal Display Device)

The cellulose ester film of the present invention is advantageously used also as a support of a retardation film for an OCB-type liquid crystal display device having a liquid crystal cell of OCB mode or a HAN-type liquid crystal display device having a liquid crystal cell of HAN mode. In the retardation film used for the OCB-type liquid crystal display device or HAN-type liquid crystal display device, it is preferred that the direction allowing the absolute value of retardation to become minimum is present neither in a plane of the retardation film nor in a normal direction. The optical properties of the retardation film used for the OCB-type liquid crystal display device or HAN-type liquid crystal display device are also determined by the optical properties of the optically anisotropic layer, the optical properties of the support, and the arrangement of the optically anisotropic layer and the support. The retardation film for use in the OCB-type liquid crystal display device or HAN-type liquid crystal display device is described in JP-A-9-197397 and the report of Mori, et al. (Jpn. J. Appl. Phys., Vol. 38, page 2837 (1999)).

### (Reflective Liquid Crystal Display Device)

The cellulose ester film of the present invention is also advantageously used as a retardation film for a reflective liquid crystal display device of TN type, STN type, HAN type or GH (Guest-Host) type. These display modes are well known from old. The TN-type reflective liquid crystal display device is described in JP-A-10-123478, International Publication No. 98/48320 (pamphlet) and Japanese Patent 3022477. The retardation film for use in the reflective liquid crystal display device is described in International Publication No. 00/65384 (pamphlet).

### (Other Liquid Crystal Display Devices)

The cellulose ester film of the present invention is also advantageously used as a support of a retardation film for an ASM-type liquid crystal display device having a liquid crystal cell of ASM (Axially Symmetric Aligned Microcell) mode. The liquid crystal cell of ASM mode is characterized in that the thickness of the cell is maintained by a position-adjustable resin spacer. Other properties are the same as those of the liquid crystal cell of TN mode. The liquid crystal cell of ASM mode and the ASM-type liquid crystal display device are described in the report of Kume, et al. (SID 98 Digest, 1089 (1998)).

### (Hardcoat Film, Antiglare Film and Antireflection Film)

The cellulose ester film of the present invention may be applied to a hardcoat film, an antiglare film or an antireflection film depending on the case. For the purpose of enhancing the visibility of a flat panel displayer such as LCD, PDP, CRT and EL, any or all of a hardcoat layer, an antiglare layer and an antireflection layer can be imparted to one surface or both surfaces of the transparent cellulose ester film of the present invention. Preferred embodiments of such an antiglare film or antireflection film are described in detail in JIII Journal of Technical Disclosure, No. 2001-1745, pp. 54-57, Japan Institute of Invention and Innovation (issued Mar. 15, 2001), and these embodiments can also be preferably used in the cellulose ester film of the present invention.

### EXAMPLES

The present invention is described in greater detail below by referring to Examples, but the present invention should not be construed as being limited to these Examples.

### Example 1

### Production of Cellulose Acylate Film 101

### [Preparation of Cellulose Acylate Solution A-1]

The following composition was charged into a mixing tank and stirred under heating to dissolve respective components, thereby preparing Cellulose Acylate Solution A-1.

{Composition of Cellulose Acylate Solution A-1}

| | |
|---|---|
| Cellulose acylate (acetyl | 100 parts by mass |
| substitution degree: 2.86, | |
| average polymerization | |
| degree: 310) | |
| Polycondensate P-7 of the | 12 parts by mass |
| invention | |
| Methylene chloride | 384 parts by mass |
| Methanol | 69 parts by mass |
| Butanol | 9 parts by mass |

### [Preparation of Matting Agent Liquid Dispersion B-1]

The following composition was charged into a disperser and stirred to dissolve respective components, thereby preparing Matting Agent Solution (B-1).

{Composition of Matting Agent Liquid Dispersion B-1}

| | |
|---|---|
| Silica particle liquid | 10.0 parts by mass |
| dispersion (average particle | |
| diameter: 16 nm), “AEROSIL | |
| R972” produced by Nihon | |
| Aerosil Co., Ltd. | |
| Methylene chloride | 72.8 parts by mass |
| Methanol | 3.9 parts by mass |
| Butanol | 0.5 parts by mass |
| Cellulose Acylate Solution A-1 | 10.3 parts by mass |

### [Preparation of Ultraviolet Absorber Solution C-1]

The following composition was charged into a separate mixing tank and stirred under heating to dissolve respective components, thereby preparing Ultraviolet Absorber Solution C-1.

{Composition of Ultraviolet Absorber Solution C-1}

| | | |
|---|---|---|
| Ultraviolet Absorber (UV-1) | 4.0 | parts by mass |
| Ultraviolet Absorber (UV-2) | 8.0 | parts by mass |
| Ultraviolet Absorber (UV-3) | 8.0 | parts by mass |
| Methylene chloride | 55.7 | parts by mass |
| Methanol | 10 | parts by mass |
| Butanol | 1.3 | parts by mass |
| Cellulose Acylate Solution A-1 | 12.9 | parts by mass |

Ultraviolet Absorber (UV-1) 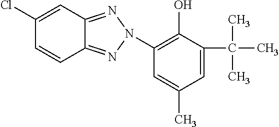
Ultraviolet Absorber (UV-2) 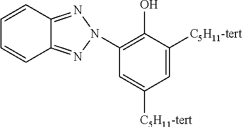
Ultraviolet Absorber (UV-3)

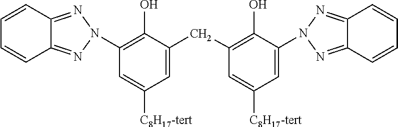

94.6 Parts by mass of Cellulose Acylate Solution A-1 and 1.3 parts by mass of Matting Agent Liquid Dispersion B-1 were mixed such that Ultraviolet Absorber (UV-2), Ultraviolet Absorber (UV-3), Ultraviolet Absorber (UV-1) and Polycondensate P-7 of the invention account for 0.4 parts by mass, 0.4 parts by mass, 0.2 parts by mass and 12 parts by mass, respectively, per 100 parts by mass of cellulose acylate, and the mixture was thoroughly stirred under heating to dissolve respective components, thereby preparing a dope. The obtained dope was heated at 30° C., passed through a caster Giesser, and cast on a mirror-surface stainless steel support that is a drum of 3 m in diameter. The surface temperature of the support was set to −5° C., the coating width was set to 1,470 mm, and the space temperature of the entire casting part was set to 15° C. At 50 cm before the end point of the casting part, the cellulose acylate film thus cast and rolled was stripped from the drum and clipped at both edges with a pin tenter. The residual solvent amount of the cellulose acylate web immediately after stripping was 270%, and the film surface temperature of the cellulose acylate web was 5° C.

The cellulose acylate web held with the pin tenter was conveyed to a drying zone. In the initial drying, a drying air of 45° C. was blown. Thereafter, the web was dried at 110° C. for 5 minutes and further at 140° C. for 10 minutes, trimmed at the both edges (each 5% of the entire width) immediately before rolling up, and after forming a knurl (knurling) of 10 mm in width and 50 μm in height at both edges, taken up into a roll of 3,000 m. The width of the thus-obtained transparent film was 1.45 m in each level. In this way, Cellulose Acylate Film Sample 101 having a thickness of 60 μm was produced.

### [Production of Cellulose Acylate Films 102 to 121]

In the production of Cellulose Acylate Film 101, in place of using Polycondensate P-7 of the present invention, the dope was prepared using the polycondensate shown in Tables 1 and 2 to give the composition shown in Table 3. Using the obtained dopes, Cellulose Acylate Films 102 to 121 were produced.

TABLE 2

| | Dicarboxylic Acid ^{*1)} | | | | Aliphatic Diol | | | | |
|---|---|---|---|---|---|---|---|---|---|
| | | | | Average | | | Average | | |
| | Aromatic | Aliphatic | | Carbon | | | Carbon | | Number |
| | Dicar- | Dicar- | Ratio of | Number of | | Ratio of | Number of | | Average |
| | boxylic | boxylic | Dicarboxylic | Dicarboxylic | Aliphatic | Diols | Aliphatic | Terminal | Molecular |
| | acid | acid | Acids (mol %) | Acid | Diol | (mol %) | Diol | End | Weight |
| Comparative | TPA | SA | 5/95 | 4.2 | ethanediol/ | 95/5 | 2.1 | diol | 3000 |
| Compound 1 ^{*2)} | | | | | diethylene | | | residue | |
| | | | | | glycol | | | structure | |
| Comparative | TPA | SA | 15/85 | 5.7 | ethanediol | 100 | 2.0 | diol | 1000 |
| Compound 2 | | | | | | | | residue | |
| | | | | | | | | structure | |
| Comparative | TPA | AA | 40/60 | 5.6 | ethanediol | 100 | 2.0 | diol | 1000 |
| Compound 3 | | | | | | | | residue | |
| | | | | | | | | structure | |
| Comparative | 2,6-NPA | AA | 75/25 | 10.5 | ethanediol | 100 | 2.0 | diol | 1000 |
| Compound 4 | | | | | | | | residue | |
| | | | | | | | | structure | |
| Comparative | — | AA | 100 | 6.0 | ethanediol | 100 | 2.0 | diol | 1000 |
| Compound 5 | | | | | | | | residue | |
| | | | | | | | | structure | |
| Comparative | — | SA | 100 | 4.0 | ethanediol | 100 | 2.0 | diol | 1000 |
| Compound 6 | | | | | | | | residue | |
| | | | | | | | | structure | |
| Comparative | TPA/PA | AA | 25/25/50 | 7.0 | 1,2- | 100 | 3.0 | diol | 1000 |
| Compound 7 | | | | | propanediol | | | residue | |
| | | | | | | | | structure | |
| Comparative | TPA | AA | 15/85 | 6.3 | 1,4- | 100 | 4.0 | diol | 1000 |
| Compound 8 | | | | | butanediol | | | residue | |
| | | | | | | | | structure | |

^{*1)} PA: phthalic acid,
TPA: terephthalic acid,
IPA: isophthalic acid,
AA: adipic acid,
SA: succinic acid,
2,6-NPA: 2,6-naphthalendicarboxylic acid.
^{*2)} Polyester polyol described in JP-A-2006-64803.

Also, the polycondensates of the present invention and the low-molecular weight plasticizers used were measured for the loss on heating by a thermobalance method. In Table 3, the mass reduction ratio when heated at 140° C. for 60 minutes is shown as the loss on heating of each compound. When the value is large, the compound may volatilize during drying of the cellulose acylate web to contaminate the production step, giving rise to a surface failure.

### [Surface Failure]

The obtained cellulose acetate film sample was taken up into a roll, and a sample in a size of 100 mm×100 mm was cut out from this stock roll and observed by a polarizing microscope at a magnification of 30 under the crossed Nicols. The following evaluation was performed using the number of portions where an extraneous substance was generated. The extraneous substance as used herein indicate a substance that is observed as a bright spot under a polarizing microscope due to a bleed-out component, a surface contamination, a deposit in the inside or on the surface of the film, or the like.

A: The number of extraneous substances is from 0 to 4.

B: The number of extraneous substances is from 5 to 10.

C: The number of extraneous substances is from 11 to 50.

D: The number of extraneous substances is 51 or more.

### [Polarizing Plate Performance]

### 1) Saponification of Film

The obtained cellulose acylate film sample was dipped in an aqueous 1.5 mol/L NaOH solution (saponification solution) kept at 55° C. for 2 minutes and then washed with water. Thereafter, the film was dipped in an aqueous 0.05 mol/L sulfuric acid solution at 25° C. for 30 seconds and then passed through a water washing bath under running water for 30 seconds to put the film into a neutral state. After repeating draining with an air knife three times to remove water, the film was dried by allowing it to stay in a drying zone at 70° for 15 seconds, thereby producing a saponified film.

### 2) Production of Polarizing Film:

In accordance with Example 1 of JP-A-2001-141926, iodine was adsorbed onto a stretched polyvinyl alcohol film to produce a 20 μm-thick polarizing film.

### 3) Lamination

Cellulose Acylate Film 101 produced was laminated to both sides of the polarizing film by using a polyvinyl alcohol-based adhesive and dried at 70° C. for 10 minutes, and the obtained polarizing plate was designated as Polarizing Plate 101. Polarizing Plates 102 to 121 were produced in the same manner by using Cellulose Acylate Films 102 to 121.

### 4) Evaluation of Polarizing Plate

Two sets of samples each obtained by laminating together one film side of the polarizing plate and a glass plate with a pressure sensitive adhesive were produced and disposed in crossed Nicols, and the transmittance (initial transmittance) was measured. The samples were left standing under the conditions of 60° C. and a relative humidity of 90% for 1,000 hours and again disposed in crossed Nicols, and the transmittance (transmittance with aging) was measured. A value obtained by multiplying a maximum variation between the initial transmittance and the transmittance with aging in the wavelength range of from 400 nm to 700 nm by 100 was used as the index of change with aging of the polarizing plate. The results are shown in Table 3.

TABLE 3

| | | Polycondensed Ester | | | | | | | |
|---|---|---|---|---|---|---|---|---|---|
| | | Average | Average | | | Loss on | | Change | |
| Cellulose | | Carbon | Carbon | | Number | Heating of | | with | |
| Acylate | Plasticizer or | Number of | Number of | | Average | Plasticizer | | Aging of | Overall |
| Film | Polycondensate | Dicarbox- | Aliphatic | | Molecular | or Polycon- | Surface | Polariz- | Evalua- |
| Sample | ^{*1)} | ylic Acid | Diol | Terminal End | Weight | densate (%) | Failure | ing Plate | tion ^{*2)} |
| 101 | P-7 (12) | 6.3 | 2.0 | diol residue | 1000 | 0.18 | A | 5 | A |
| | | | | structure | | | | | |
| 102 | P-13 (12) | 7.0 | 2.0 | diol residue | 1000 | 0.15 | A | 5 | A |
| | | | | structure | | | | | |
| 103 | P-15 (12) | 6.5 | 2.0 | diol residue | 1000 | 0.13 | A | 5 | A |
| | | | | structure | | | | | |
| 104 | P-16 (12) | 7.0 | 2.5 | diol residue | 1000 | 0.16 | A | 5 | A |
| | | | | structure | | | | | |
| 105 | P-17 (12) | 7.0 | 2.0 | acetyl ester | 1000 | 0.15 | A | 3 | A |
| | | | | residue structure | | | | | |
| 106 | P-25 (12) | 7.0 | 2.0 | propionyl ester | 1000 | 0.21 | A | 4 | A |
| | | | | residue structure | | | | | |
| 107 | P-9 (12) | 7.5 | 2.0 | diol residue | 1000 | 0.15 | A | 5 | A |
| | | | | structure | | | | | |
| 108 | Comparative | 5.7 | 2.0 | diol residue | 1000 | 0.16 | A | 12 | D |
| | Compound 2 (12) | | | structure | | | | | |
| 109 | Comparative | 10.5 | 2.0 | diol residue | 1000 | 0.17 | C | 15 | D |
| | Compound 4 (12) | | | structure | | | | | |
| 110 | Comparative | 4.0 | 2.0 | diol residue | 1000 | 0.32 | B | 22 | D |
| | Compound 6 (12) | | | structure | | | | | |
| 111 | Comparative | 7.0 | 3.0 | diol residue | 1000 | 0.55 | C | 18 | D |
| | Compound 7 (12) | | | structure | | | | | |
| 112 | Comparative | 6.3 | 4.0 | diol residue | 1000 | 0.86 | C | 23 | D |
| | Compound 8 (12) | | | structure | | | | | |
| 113 | P-33 (12) | 7.0 | 2.0 | acetyl ester | 650 | 0.71 | C | 6 | C |
| | | | | residue structure | | | | | |
| 114 | P-34 (12) | 7.0 | 2.0 | acetyl ester | 2200 | 0.12 | C | 5 | C |
| | | | | residue structure | | | | | |
| 115 | P-35 (12) | 7.0 | 2.0 | benzoyl ester | 1000 | 1.2 | C | 4 | C |
| | | | | residue structure | | | | | |
| 116 | P-36 (12) | 7.0 | 2.0 | butyryl ester | 1000 | 0.8 | C | 5 | C |
| | | | | residue structure | | | | | |
| 117 | P-37 (12) | 7.0 | 2.0 | 2-ethylhexyl | 1000 | 1.5 | C | 4 | C |
| | | | | ester residue | | | | | |
| | | | | structure | | | | | |
| 118 | triphenyl | | | | | 7.5 (total) | D | 6 | D |
| | phosphate (5.0), | | | | | | | | |
| | biphenyldiphenyl | | | | | | | | |
| | phosphate (3.0), | | | | | | | | |
| | ethylphthalyl | | | | | | | | |
| | ethyl glycolate | | | | | | | | |
| | (4.0) | | | | | | | | |
| 119 | P-11 (12) | 6.0 | 2.0 | diol residue | 1000 | 0.22 | A | 6 | A |
| | | | | structure | | | | | |
| 120 | P-38 (12) | 10.0 | 2.0 | diol residue | 1000 | 0.18 | B | 6 | B |
| | | | | structure | | | | | |
| 121 | P-42 (12) | 7.0 | 2.0 | acetyl ester | 850 | 0.25 | A | 5 | A |
| | | | | residue structure | | | | | |

^{*1)} The value in the parenthesis is the amount added (parts by mass) per 100 parts by mass of cellulosen acylate.
^{*2)} Overall evaluation: Preference is given to the fact that the change with aging of polarizing plate is small;
A: very good,
B: good,
C: slightly bad, and
D: bad.

The cellulose ester film containing the polycondensed ester of the present invention is small in the loss on heating and allows for reduction in the process contamination and good surface profile of the film. Also, the change in performance of the polarizing plate is small, and the film is excellent as a protective film.

When the average carbon number of the dicarboxylic acid forming the polycondensed ester is less than the range of the present invention, the effect in terms of the change in performance of the polarizing plate is insufficient and although the reason therefor is unclear, this is presumed to be caused due to, for example, reduction in the water permeability of the film with aging (108, 110). Conversely, when the average carbon number of the dicarboxylic acid exceeds the range of the present invention, compatibility with cellulose acylate is decreased and in Cellulose Acylate Film 109, bleed-out is locally generated.

When the average carbon number of the aliphatic diol forming the polycondensed ester exceeds the range of the present invention, the loss on heating of the compound is increased and a surface failure considered to be attributable to the process contamination at the drying of the cellulose acylate web is generated (111, 112). Also, when the terminal end of the polycondensed ester is capped, in the case of a benzoyl ester residue structure, a butyryl ester residue structure, a 2-ethylhexyl ester residue structure and the like, in which the carbon number of the terminal end structure is large, the change in performance of the polarizing plate is small, but the loss on heating of the compound is large and a surface failure is sometimes generated (115, 116 and 117).

In the case of an acetyl or propionyl ester residue structure in which the carbon number of the terminal end structure is small and in the case where the terminal end is uncapped and the average carbon number of the aliphatic diol is within the range of the present invention, low molecular components can be removed by depressurization or the like in the process of synthesizing the polycondensed ester. Accordingly, with these structures, the loss on heating of the compound is small and the process contamination can be reduced.

When the average molecular weight of the polycondensed ester is less than 700, increase of low molecular components tends to affect the loss on heating (113), and when the average molecular weight exceeds 2,000, bleed-out is liable to be caused (114).

### Example 2

### Production of Cellulose Acylate Film 201

### [Preparation of Cellulose Acylate Solution A-2]

The following composition was charged into a mixing tank and stirred to dissolve respective components, and the resulting solution was further heated at 90° C. for about 10 minutes and then filtered through a paper filter having an average pore size of 34 μm and a sintered metal filter having an average pore size of 10 μm.

{Composition of Cellulose Acylate Solution A-2}

| | |
|---|---|
| Cellulose acylate (acetyl | 100.0 parts by mass |
| substitution degree: 2.86, | |
| average polymerization | |
| degree: 310) | |
| Polycondensate P-13 of the | 12.0 parts by mass |
| invention | |
| Methylene chloride | 403.0 parts by mass |
| Methanol | 60.2 parts by mass |

### [Preparation of Matting Agent Liquid Dispersion B-2]

The following composition containing Cellulose Acylate Solution A-2 produced by the method above was charged into a disperser, and a matting agent liquid dispersion was prepared.

{Composition of Matting Agent Liquid Dispersion B-2}

| | |
|---|---|
| Silica particle having an | 2.0 parts by mass |
| average particle diameter of | |
| 16 nm; aerosil R972 produced | |
| by Nihon Aerosil Co., Ltd. | |
| Methylene chloride | 72.4 parts by mass |
| Methanol | 10.8 parts by mass |
| Cellulose Acylate Solution A-2 | 10.3 parts by mass |

### [Preparation of Retardation Developer Solution C-2]

The following composition containing Cellulose Acylate Solution A-2 produced by the method above was charged into a mixing tank and stirred under heating to dissolve the components, thereby preparing Retardation Developer Solution C-2.

{Composition of Retardation Developer Solution C-2}

| | | |
|---|---|---|
| Compound A shown below | 15.0 | parts by mass |
| Compound B shown below | 5.0 | parts by mass |
| Methylene chloride | 63.5 | parts by mass |
| Methanol | 9.5 | parts by mass |
| Cellulose Acylate Solution A-2 | 14.0 | parts by mass |

Compound A: 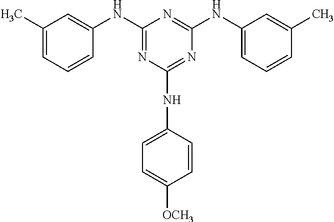
Compound B:

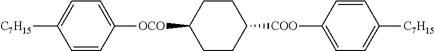

Parts by mass of Cellulose Acylate Solution A-2, 1.35 parts by mass of Matting Agent Liquid Dispersion B-2 and Retardation Developer Solution C-2 in such an amount that the retardation developers in the cellulose acylate film, that is, Compound A and Compound B, account for 3.0 parts by mass and 2.0 parts by mass, respectively, per 100 parts by mass of cellulose acylate, were mixed to prepare a dope for film production.

### (Casting/Stretching Step)

A coat hanger-type die made of a two-phase stainless steel having a mixed composition of austenite phase and ferrite phase was used. A stainless steel-made endless band of 100 m in length was used as the support. The temperature in the casting chamber provided with the casting die, the support and the like was kept at 35° C. At the point when the solvent ratio in the dope became 45 mass % on the dry weight basis, the film was stripped from the casting support. At this time, the peel tension was 8 kgf/m, and the stripping rate (stripping roll draw) was appropriately set to enable stripping in the range of from 100.1% to 110% based on the rate of the support. The stripped film was conveyed through a drying zone of a tenter while fixing both ends by the tenter having clips. The inside of the tenter was divided into 3 zones, and the dry air temperature in respective zones was set to 90° C., 100° C. and 110° C. from the upstream side. In this way, a cellulose acylate film having a residual solvent amount of less than 1% was produced.

The residual solvent amount in the film formed on the support is expressed by the following formula:

residual solvent amount=(mass of residual volatile component/mass of film after treat treatment)×100%

Incidentally, the mass of residual volatile component is a value obtained by subtracting the mass of film after heat treatment from the mass of film before heat treatment when the film is heat-treated at 115° C. for 1 hour.

Subsequently, the obtained film was transversely stretched to a stretch ratio of 25% at a stretch rate of 30%/min by using a tenter under the condition of 180° C. The finished cellulose acylate film had a thickness of 70 μm. This film was designated as Cellulose Acylate Film 201.

Cellulose Acetate Films 202 to 209 were produced in the same manner as Cellulose Acylate Film 201 except for changing the polycondensate (or low molecular weight plasticizer) as shown in Table 4 below.

### [Surface Failure]

The surface failure was evaluated in the same manner as in Example 1 by the number of portions where an extraneous substance was generated in the obtained cellulose acetate film sample.

### [Measurement of Retardation]

Re and Rth were measured by the method described above at a measurement wavelength of 590 nm and at 25° C. and 60% RH by using an automatic birefringence meter (KOBRA 21ADH, manufactured by Oji Scientific Instruments).

TABLE 4

| | | Polycondensed Ester | | | | | | |
|---|---|---|---|---|---|---|---|---|
| | | Average | Average | | Number | | | |
| Cellulose | | Carbon Number | Carbon Number | | Average | | | |
| Acylate | Plasticizer or | of Dicarbox- | of Aliphatic | | Molecular | Surface | Re | Rth |
| Film Sample | Polycondensate ^{*1)} | ylic Acid | Diol | Terminal End | Weight | Failure | (nm) | (nm) |
| 201 | P-13 (12) | 7.0 | 2.0 | diol residue structure | 1000 | B | 53 | 118 |
| 202 | P-9 (12) | 7.5 | 2.0 | diol residue structure | 1000 | B | 65 | 162 |
| 203 | P-15 (12) | 6.5 | 2.0 | diol residue structure | 1000 | B | 55 | 120 |
| 204 | P-20 (12) | 7.0 | 2.0 | acetyl ester residue | 1000 | B | 51 | 114 |
| | | | | structure | | | | |
| 205 | P-28 (12) | 7.8 | 2.0 | diol residue structure | 1000 | B | 66 | 167 |
| 206 | Comparative | 4.2 | 2.1 | diol residue structure | 1000 | C | 42 | 101 |
| | Compound 1 (12) | | | | | | | |
| 207 | P-35 (12) | 7.0 | 2.0 | benzoyl ester residue | 1000 | C | 58 | 121 |
| | | | | structure | | | | |
| 208 | triphenyl | | | | | D | 55 | 122 |
| | phosphate (6.0), | | | | | | | |
| | biphenyldiphenyl | | | | | | | |
| | phosphate (4.0) | | | | | | | |
| 209 | P-42 (12) | 7.0 | 2.0 | acetyl ester residue | 850 | B | 64 | 151 |
| | | | | structure | | | | |

^{*1)} The value in the parenthesis is the amount added (parts by mass) per 100 parts by mass of cellulose
acylate.

When the average carbon number of the dicarboxylic acid forming the polycondensate is less than the range of the present invention, decomposition occurs under high-temperature heating and the process is contaminated due to volatilization of low molecular components, which is liable to cause a surface failure (206). As described in Example 1, in the case where the terminal end structure is a benzoyl ester, Re and Rth can be adjusted to preferred values, but the loss on heating is large and the film tends to be inferior in view of surface failure (207). The same applies to the case where the polycondensate of the present invention is not contained and a low molecular weight plasticizer is used (208).

According to the polycondensate of the present invention, a cellulose acetate film having high Re and Rth and being suitable for a retardation film can be obtained without impairing the yield due to surface failure.

### Example 3

### Mounting Test on VA-Mode Liquid Crystal Displace Device)

Cellulose Acetate Film 204 and a commercially available cellulose triacylate film (FUJITAC TD80UF, produced by Fujifilm Corporation) were subjected to saponification treatment in the same manner as in Example 1. Furthermore, the polarizer produced in Example 1 was sandwiched with these two films by using a polyvinyl alcohol-based adhesive and dried at 70° C. for 10 minutes or more.

These members were disposed such that the transmission axis of the polarizing film runs in parallel to the slow axis of the cellulose acylate film of the present invention and the transmission axis of the polarizing film crosses at right angles with the slow axis of the commercially available cellulose triacylate film.

### <Production of Liquid Crystal Cell>

A cell gap of 3.6 μm was defined between substrates, and a liquid crystal material having negative dielectric anisotropy (“MLC6608”, produced by Merck & Co. Inc.) was poured dropwise and sealed therein to form a liquid crystal layer between the substrates, whereby a liquid crystal cell was produced. The retardation of the liquid crystal layer (that is, the product Δn·d of the thickness d (μm) of the liquid crystal layer and the refractive index anisotropy (Δn)) was set to 300 nm. Incidentally, the liquid crystal material was oriented in vertical alignment.

### <Mounting on VA Panel>

As the upper polarizing plate and the lower polarizing plate (on the backlight side) of a liquid crystal display device using the vertically aligned liquid crystal cell produced above, a polarizing plate having thereon Cellulose Acylate Film 204 was disposed such that Cellulose Acylate Film 204 comes to the liquid crystal cell side. The upper polarizing plate and the lower polarizing plate were laminated to the liquid crystal cell via a pressure sensitive adhesive. The polarizing plates were disposed in a crossed Nicols configuration such that the transmission axis of the upper polarizing plate runs in the vertical direction and the transmission axis of the lower polarizing plate runs in the transverse direction.

A rectangular wave voltage of 55 Hz was applied to the liquid crystal cell. The mode was set to a normally black mode with a white display of 5 V and a black display of 0 V. The black display transmittance (%) at a viewing angle in the direction defined by an azimuth angle of 45° and a polar angle of 60° of black display and a color shift between the color at an azimuth angle of 45° and a polar angle 60° and the color at an azimuth angle of 180° and a polar angle of 60° were determined.

Also, the transmittance ratio (white display/black display) was taken as the contrast ratio, and the viewing angle (the polar angle range where the contrast ratio is 10 or more and no gradation inversion occurs on the black side) was measured in 8 stages of black display (L1) to white display (L8) by using a measuring meter (EZ-Contrast 160D, manufactured by ELDIM).

The produced liquid crystal display device was observed, as a result, in the liquid crystal panel using the cellulose acylate film of the present invention, a neutral black display could be realized in both the front direction and the viewing angle direction.

Furthermore, the viewing angle (a polar angle range where the contrast ratio is 10 or more and no gradation inversion occurs on the black side) was 80° or more in terms of polar angle in the vertical and transverse directions, and the color shirt at black display was less than 0.02, revealing that good results were obtained.

### Example 4

### Mounting Test on TN-Mode Monitor

### (Production of Cellulose Acylate Film 401)

A film was produced by using, as the retardation developer, Compound C shown below to account for 2.0 mass % per 100 parts by mass of cellulose acylate in place of Compounds A and Compound B in Cellulose Acetate Film 204 of Example 2. At this time, the casting die and various conditions were adjusted such that the thickness became 40 μm. The obtained cellulose acylate film having a residual solvent amount of less than 0.2% was designated as Sample 401.

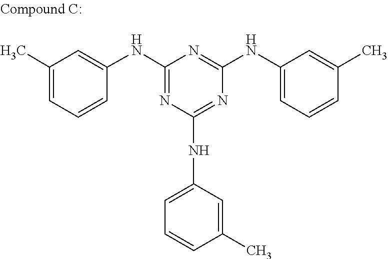

The retardation of Cellulose Acylate Film Sample 401 was measured by the above-described method, and Rth was found to be 81 nm.

### (Saponification Treatment)

A solution having the following composition was coated in an amount of 5.2 ml/m² on Cellulose Acetate Film 401 and dried at 60° C. for 10 seconds. The surface of the film was washed with running water for 10 seconds, and air at 25° C. was blown to dry the film surface.

<Composition of Saponification Solution>

| | |
|---|---|
| Isopropyl alcohol | 818 parts by mass |
| Water | 167 parts by mass |
| Propylene glycol | 187 parts by mass |
| Potassium hydroxide | 80 parts by mass |

### (Formation of Oriented Film)

A coating solution having the following composition was coated in an amount of 24 ml/m² on the band surface side of saponified Cellulose Acetate Film 401 by using a #14 wire bar coater and dried with warm air at 60° C. for 60 seconds and further with warm air at 90° C. for 150 seconds to form an oriented film.

Subsequently, the oriented film formed was subjected to a rubbing treatment in the direction of 45° with respect to the stretching direction (agreeing with the slow axis) of Cellulose Acetate Film 401.

<Composition of Coating Solution for Oriented Film>

| | | |
|---|---|---|
| Modified polyvinyl alcohol having the structure | 20 | parts by mass |
| shown below | | |
| Water | 360 | parts by mass |
| Methanol | 120 | parts by mass |
| Glutaraldehyde (crosslinking agent) | 1.0 | parts by mass |

Modified Polyvinyl Alcohol:

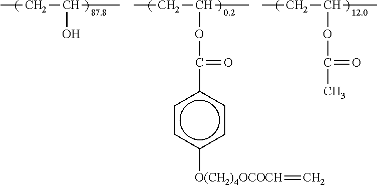

### (Formation of Optically Anisotropic Layer and Production of Optically Compensatory Film)

A coating solution obtained by dissolving 91 parts by mass of the discotic compound shown below, 9 parts by mass of ethylene oxide-modified trimethylolpropane triacrylate (V#360, produced by Osaka Organic Chemical Industry Ltd.), 1.5 parts by mass of cellulose acetate butyrate (CAB531-1, Produced by Eastman Chemical Company), 3 parts by mass of a photopolymerization initiator (IRGACURE 907, produce by Ciba-Geigy AG) and 1 part by mass of a sensitizer (KAYACURE DETX, produced by Nippon Kayaku Co., Ltd.) in 214.2 parts by mass of methyl ethyl ketone was coated in an amount of 5.2 ml/m² on the oriented film above by using a #3 wire bar coater. The resulting film was laminated to a metal frame and heated in a constant-temperature bath at 130° C. for 2 minutes to align the discotic compound. Subsequently, a UV ray was irradiated thereon for 1 minute by using a high-pressure mercury lamp of 120 W/cm at 90° C., thereby polymerizing the discotic compound, and the film was then allowed to cool. In this way, an optically anisotropic layer was formed and at the same time, Stacked Retardation Film 401 was produced.

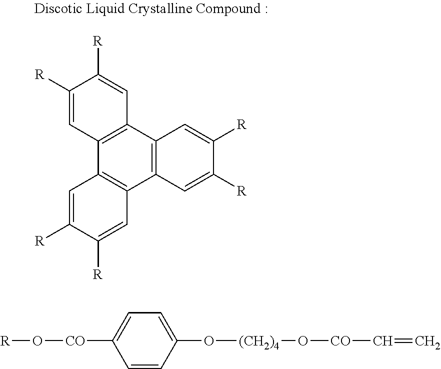

### <<Production of Polarizing Plate>>

Stacked Retardation Film 401 was subjected to an alkali treatment with an aqueous 2.5 N sodium hydroxide solution at 40° C. for 60 seconds and washed with water for 3 minutes to form a saponified layer, thereby obtaining an alkali-treated film.

Subsequently, in the same manner as in Example 3, alkali-treated Stacked Retardation Film 401 was laminated to one side of the polarizing film and a 40 μm-thick cellulose triacetate film (FUJITAC, produced by Fujifilm Corporation) similarly subjected to an alkali treatment was laminated to the opposite side of the polarizing film. In this way, Polarizing Plate Sample 401 was produced.

### <Evaluation of Viewing Angle>

A polarizing plate of a TFT-TN liquid crystal panel, Model LA-1529HM, manufactured by NEC Corporation was stripped, and an optically compensatory film provided between the polarizing plate and the liquid crystal panel was stripped. Polarizing Plate Sample 401 produced by the method above was disposed and laminated by arranging the retardation film side between the polarizer and the liquid crystal panel. This polarizing plate was laminated on both the backlight side and the image observation surface side of the liquid crystal panel.

The monitor was driven in a personal computer, and the contrast ratio between white display/black display was measured using Ez-Contrast manufactured by ELDIM. The angle from the normal direction of the liquid crystal panel, showing a contrast ratio of 10 or more, was measured for each of up/down and right/left directions, as a result, a good result of 40° or more was obtained in all of the up/down and right/left directions.

### Example 5

### Production of Cellulose Ester Film Sample 501

(Preparation of Fine Particle Liquid Dispersion B)

| | |
|---|---|
| AEROSIL 200 (produced by | 11 parts by mass |
| Nippon Aerosil Co., Ltd.) | |
| Ethanol | 89 parts by mass |

These components were mixed with stirring by a dissolver for 30 minutes and then dispersed by a Manton-Gaulin.

(Production of Fine Particle Addition Solution B)

| | |
|---|---|
| Cellulose Ester B-1: | 4 parts by mass |
| cellulose acetate propionate | |
| (substitution degree of | |
| acetyl group: 1.7, | |
| substitution degree of | |
| propionyl group: 0.8, number | |
| average molecular weight: | |
| 54,000 (Mw/Mn = 2.9)) | |
| Methylene chloride | 99 parts by mass |
| Fine Particle Liquid | 11 parts by mass |
| Dispersion B | |

These components were charged into a closed vessel and heated with stirring to completely dissolve the components, and the solution was filtered through AZUMI PAPER FILTER No. 244, produced by Azumi Filterpaper Co., Ltd., to prepare Fine Particle Addition Solution B.

(Preparation of Dope Solution B)

| | |
|---|---|
| Cellulose Ester B-1 | 100 parts by mass |
| Polycondensate P-42 | 12.0 parts by mass |
| Methylene chloride | 300 parts by mass |
| Ethanol | 57 parts by mass |

These components were charged into a closed vessel and heated with stirring to completely dissolve the components, and the solution was filtered through AZUMI PAPER FILTER No. 244, produced by Azumi Filterpaper Co., Ltd., to prepare a dope solution.

Dope Solution B and Fine Particle Addition Solution B were thoroughly mixed by an in-line mixer to account for 100 parts by mass and 2 parts by mass, respectively, and the mixture was uniformly cast in a width of 2,000 mm on a stainless steel band support. The solvent was evaporated on the stainless steel band support until the residual solvent amount became 110%, and the resulting film was separated from the stainless steel band support. At the separation, the film was stretched by applying a tension such that the vertical (MD) stretch ratio became 1.02 times. Subsequently, the film was stretched by clipping both edges with a tenter such that the width-direction (TD) stretch ratio became 1.3 times. The residual solvent amount at the start of stretching was 30%. The film still in a clipped state was conveyed in a drying zone at 125° C. for 30 minutes and then slit into a width of 1,500 mm to obtain Cellulose Ester Film Sample 501 having a thickness of 40 μm.

### (Production of Cellulose Ester Film Sample 502)

Cellulose Ester Film Sample 502 was obtained in the same manner as Sample 501 except for using solutions prepared by replacing Cellulose Ester B-1 in Fine Particle Addition Solution B and Dope Solution B by Cellulose Ester B-2 (cellulose acetate propionate; substitution degree of acetyl group: 1.65, substitution degree of propionyl group: 0.9, number average molecular weight: 54,000 (Mw/Mn=2.9)) and replacing Polycondensate P-42 in Dope Solution B by P-20.

### (Production of Cellulose Ester Film Sample 503)

Cellulose Ester Film Sample 503 was obtained in the same manner as Sample 501 except for using solutions prepared by replacing Cellulose Ester B-1 in Fine Particle Addition Solution B and Dope Solution B by Cellulose Ester B-3 (cellulose acetate propionate; substitution degree of acetyl group: 1.45, substitution degree of propionyl group: 1.1, number average molecular weight: 54,000 (Mw/Mn=2.9)) and replacing Polycondensate P-42 in Dope Solution B by P-20.

Cellulose Ester Film Samples 501 to 503 obtained were evaluated for the surface failure and optical properties (Re, Rth) in the same manner as in Example 2. As shown in Table 5, good results were obtained.

TABLE 5

| | Cellulose Acylate | | | Polycondensed Ester | | | | | | | |
|---|---|---|---|---|---|---|---|---|---|---|---|
| | | | Acyl | | Average | Average | | | | | |
| Cellulose | Propionyl | Acetyl | Substi- | | Carbon | Carbon | | Number | | | |
| Acylate | Substi- | Substi- | tution | | Number of | Number of | | Average | | | |
| Film | tution | tution | Degree | | Dicarbox- | Aliphatic | | Molecular | Surface | Re | Rth |
| Sample | Degree | Degree | (total) | *1) | ylic Acid | Diol | Terminal End | Weight | Failure | (nm) | (nm) |
| 501 | 0.8 | 1.7 | 2.50 | P-42 (12) | 7.0 | 2.0 | acetyl ester | 850 | B | 56 | 118 |
| | | | | | | | residue | | | | |
| | | | | | | | structure | | | | |
| 502 | 0.9 | 1.65 | 2.55 | P-20 (12) | 7.0 | 2.0 | acetyl ester | 1000 | B | 55 | 112 |
| | | | | | | | residue | | | | |
| | | | | | | | structure | | | | |
| 503 | 1.1 | 1.45 | 2.55 | P-20 (12) | 7.0 | 2.0 | acetyl ester | 1000 | B | 54 | 110 |
| | | | | | | | residue | | | | |
| | | | | | | | structure | | | | |

*1) The value in the parenthesis is the amount added (parts by mass) per 100 parts by mass of
cellulose acylate.

### Example 6

### Production of Cellulose Ester Film Sample 601

Cellulose Ester Film Sample 601 was produced in the same manner as Sample 204 of Example 2 except that the cellulose ester was replaced by a cellulose acylate having an acetyl substitution degree of 2.42, Compounds A and B were not used, and Polycondensate P-19 was used in place of P-20 and at the same time, used to account for 20 parts by mass per 100 parts by mass of cellulose acylate.

### (Production of Cellulose Ester Film Samples 602 and 603)

Cellulose Ester Film Samples 602 and 603 were produced in the same manner as Sample 601 except for replacing Polycondensate P-20 by P-2 and P-41, respectively, each in 1 times weight.

Cellulose Ester. Film Samples 601 to 603 obtained were evaluated for the surface failure and optical properties (Re, Rth) in the same manner as in Example 2. As shown in Table 6 below, good results were obtained.

TABLE 6

| | Polycondensed Ester | | | | | | | |
|---|---|---|---|---|---|---|---|---|
| Cellulose | | Average Carbon | Average | | Number | | | |
| Acylate | | Number of | Carbon Number | | Average | | | |
| Film | | Dicarboxylic | of Aliphatic | | Molecular | Surface | Re | Rth |
| Sample | *1) | Acid | Diol | Terminal End | Weight | Failure | (nm) | (nm) |
| 601 | P-19 (20) | 6.5 | 2.0 | acetyl ester | 1000 | B | 53 | 108 |
| | | | | residue structure | | | | |
| 602 | P-2 (20) | 7.0 | 2.0 | acetyl ester | 1000 | B | 54 | 114 |
| | | | | residue structure | | | | |
| 603 | P-41 (20) | 6.5 | 2.0 | acetyl ester | 850 | B | 55 | 117 |
| | | | | residue structure | | | | |

*1) The value in the parenthesis is the amount added (parts by mass) per 100 parts by mass of cellulose
acylate.

### INDUSTRIAL APPLICABILITY

The cellulose ester film of the present invention can be used, for example, as a retardation film or a polarizing plate protective film and is excellent in view of productivity, surface failure, optical properties, durability and the like.

While the invention has been described in detail and with reference to specific embodiments thereof, it will be apparent to one skilled in the art that various changes and modifications can be made therein without departing from the spirit and scope of the invention.

This application is based on Japanese Patent Application (Patent Application No. 2008-56913) filed on Mar. 6, 2008 and Japanese Patent Application (Patent Application No. 2008-299454) filed on Nov. 25, 2008, the contents of which are incorporated herein by way of reference.

1. A cellulose ester film comprising at least one kind of a polycondensed ester obtained from at least one kind of an aliphatic diol having an average carbon number of 2.0 to 2.5 and a dicarboxylic acid mixture containing at least one kind of an aromatic ring-containing dicarboxylic acid and at least one kind of an aliphatic dicarboxylic acid and having an average carbon number of 6.0 to 10.0.

2. The cellulose ester film as claimed in claim 1, wherein said polycondensed ester is a polyester polyol or a terminal end of said polycondensed ester is an ester-forming derivative of an aliphatic monocarboxylic acid having a carbon number of 3 or less.

3. The cellulose ester film as claimed in claim 1, wherein a terminal end of said polycondensed ester is an ester-forming derivative of acetic acid or propionic acid.

4. The cellulose ester film as claimed in claim 1, wherein said cellulose ester film is obtained by stretching, and the stretch ratio is from 5 to 100% in a direction perpendicular to a conveying direction (in a width direction).

5. The cellulose ester film as claimed in claim 1, which contains a compound having at least two or more aromatic rings.

6. The cellulose ester film as claimed in claim 4, wherein said stretching is performed with a residual solvent amount of 5% or less, the residual solvent amount being defined as follows:
residual solvent amount=(mass of residual volatile component/mass of film after heat treatment)×100%.

7. The cellulose ester film as claimed in claim 1, wherein said cellulose ester film contains a cellulose acylate and an acyl substitution degree of said cellulose acylate is from 2.00 to 2.95.

8. A retardation film comprising the cellulose ester film claimed in claim 1 having thereon an optically anisotropic layer containing at least one kind of a liquid crystalline compound.

9. A polarizing plate comprising a polarizer having on both sides thereof a protective film, wherein at least one of said protective films is the cellulose ester film claimed in claim 1 or the retardation film claimed in claim 8.

10. A liquid crystal display device comprising a liquid crystal cell and two polarizing plates disposed on both sides of the liquid crystal cell, wherein at least one of said polarizing plates is the polarizing plate claimed in claim 9.

11. The liquid crystal display device as claimed in claim 10, wherein said liquid crystal cell is a vertically aligned-mode or TN-mode liquid crystal cell.
